(19) United States
(12) Patent Application Publication
(10) Pub. No.: US 2026/0211515 A1
(43) Pub. Date: Jul. 23, 2026

(54) INTERACTION METHOD FOR EXTERNAL OBJECT AND TOUCH DISPLAY DEVICE, TOUCH PROCESSOR, TOUCH DISPLAY DEVICE, AND TOUCH SYSTEM

(71) Applicants: Beijing BOE Display Technology Co., Ltd., Beijing (CN); BOE Technology Group Co., Ltd., Beijing (CN)

(72) Inventors: Zhaohui MENG, Beijing (CN); Shengbao DUN, Beijing (CN)

(21) Appl. No.: 19/141,351

(22) PCT Filed: Feb. 23, 2024
(86) PCT No.: PCT/CN2024/078343

§ 371 Date: Jun. 20, 2025

(30) Foreign Application Priority Data
Dec. 23, 2022 (CN) 202211663504.2
Oct. 19, 2023 (WO) PCT/CN2023/125483

(51) Int. Cl. G06F 3/038; G06F 3/0354; G06F 3/041; G06F 3/044

(52) U.S. Cl. CPC G06F 3/038; G06F 3/03545; G06F 3/0412; G06F 3/0442

(57) ABSTRACT

An interaction method for an external object and a touch display device, which includes: one image refresh cycle of a touch display device includes multiple display driving time segments and multiple non-display driving time segments alternating with each other, and the multiple non-display driving time segments includes multiple first touch time segments and multiple second touch time segments, each first touch time segment or each second touch time segment respectively being one non-display driving time segment, one image refresh cycle includes at least two second touch time segments between at least two first touch time segments; and an external object includes at least one of an active object and a passive object, the touch display device receives a communication signal from the active object, senses a touch signal of the passive object via a touch sensor during multiple first touch time segments.

### CROSS-REFERENCE TO RELATED APPLICATIONS

The present application is a U.S. National Phase Entry of International Application PCT/CN2024/078343 having an international filing date of Feb. 23, 2024, which claims priorities to Chinese patent application No. 202211663504.2 filed on Dec. 23, 2022 and PCT patent application No. PCT/CN2023/125483 filed on Oct. 19, 2023, and entire contents of the above-identified applications are incorporated herein by reference.

### TECHNICAL FIELD

The present disclosure relates to the field of display technologies, and particularly to an interaction method between an external object and a touch display device, a touch processor, a computer-readable storage medium, a touch display device, and a touch system.

### BACKGROUND

With the development and progress of information technologies, people's demand for a touch display device with both a touch function and a display function is gradually increasing. Display devices such as a liquid crystal display device, an organic light emitting diode display device, and a plasma display device may all be incorporated with a touch function to form the touch display device. The touch display device allows users to input information or commands in an intuitive and convenient manner without need of using components such as keys, a keyboard, or a mouse. Moreover, more and more application software requires high-precision touch for the touch display device, so applications of a handwriting pen (including an active pen and a passive pen) are increasing, and a performance requirement for the handwriting pen is gradually improved. A pen touch technology has enabled communication between the handwriting pen (e.g., an active pen) and the touch display device, achieving bi-directional data transmission between the pen and the touch display device. Although a variety of communication methods between the pen and the touch display device have been developed at present, the existing communication methods can hardly support improvement of display performance of the touch display device.

### SUMMARY

According to a first aspect of the present disclosure, an interaction method between an external object and a touch display device is provided, the touch display device includes a touch sensor, and the interaction method includes the following contents. one image refresh cycle of the touch display device includes a plurality of display driving time segments and a plurality of non-display driving time segments, a display driving time segment and a non-display driving time segment alternate with each other, the plurality of non-display driving time segments include a plurality of first touch time segments and a plurality of second touch time segments, each of the first touch time segments or each of the second touch time segments is one of the non-display driving time segments, respectively, and the one image refresh cycle includes at least two of the second touch time segments located between two adjacent first touch time segments; the external object includes at least one of an active object and a passive object, the touch display device receives a communication signal from the active object, senses a touch signal of the passive object via the touch sensor during the plurality of first touch time segments to detect touch of the passive object to the touch display device, and senses a touch signal of the active object via the touch sensor during the plurality of second touch time segments to detect touch of the active object to the touch display device.

In some embodiments, there is at least one second touch time segment between each two adjacent first touch time segments in the one image refresh cycle.

In some embodiments, the one image refresh cycle includes eight second touch time segments and four first touch time segments, there are two second touch time segments between each two adjacent first touch time segments of the four first touch time segments.

In some embodiments, the one image refresh cycle includes four second touch time segments and four first touch time segments, there is one second touch time segment between each two adjacent first touch time segments of the four first touch time segments.

In some embodiments, detecting touch of the passive object to the touch display device and detecting touch of the active object to the touch display device includes collecting a touch signal of the passive object sensed by the touch sensor and collecting a touch signal of the active object sensed by the touch sensor, respectively, wherein the plurality of non-display time segments also include a noise processing time segment, the method further includes: acquiring a signal-to-noise ratio of at least one of the touch signal of the active object and the touch signal of the passive object during the noise processing time segment; and adjusting a frequency at which the at least one of the touch signal of the active object and the touch signal of the passive object is collected in response to the signal-to-noise ratio being lower than a threshold.

In some embodiments, each first touch time segment of the plurality of first touch time segments and each second touch time of the plurality of second touch time segments have a same time length, and the time length does not exceed 180 microseconds.

In some embodiments, the plurality of non-display time segments in the one image refresh cycle also includes a noise processing time segment, and sums of quantities of first touch time segments and second touch time segments on two sides of the noise processing time segment are equal.

In some embodiments, the interaction method further includes: if the touch display device does not receive a communication signal from the active object, the touch display device senses the touch signal of the passive object via the touch sensor during the plurality of second touch time segments to detect touch of the passive object to the touch display device.

In some embodiments, the interaction method further includes: if the touch display device does not receive a communication signal from the active object, the touch display device does not detect touch of the at least one of the active object and the passive object to the touch display device during the plurality of first touch time segments.

In some embodiments, the interaction method further includes: if the touch display device does not receive a communication signal from the active object, the touch display device senses the touch signal of the passive object via the touch sensor during the plurality of first touch time segments and the plurality of second touch time segments to detect touch of the passive object to the touch display device.

In some embodiments, the one image refresh cycle includes six second touch time segments and four first touch time segments, there are two second touch time segments between each two adjacent first touch time segments of the four first touch time segments.

In some embodiments, the one image refresh cycle includes five second touch time segments and four first touch time segments, there is one second touch time segment between each two adjacent first touch time segments of the four first touch time segments.

In some embodiments, the interaction method between the external object and the touch display device also includes: the touch display device transmits an uplink signal to the external object, and periodically transmits the uplink signal to the external object with an image refresh cycle of the touch display device as a transmission cycle, and the uplink signal includes 7 bits of data.

In some embodiments, the uplink signal is encoded using Direct Sequence Spread Spectrum, and each bit of data is encoded as a P-bit spread spectrum code sequence, herein, P is a positive integer.

In some embodiments, each bit of data is encoded as a 31-bit spread spectrum code sequence.

In some embodiments, the touch signal of the active object includes pressure information for indicating a touch pressure of the active object for the touch display device, and the pressure information includes multi-bit pressure information codes. Sensing the touch signal of the active object via the touch sensor during the plurality of second touch time segments to detect touch of the active object to the touch display device includes: receiving pressure information codes of different bits of the multi-bit pressure information codes via the touch sensor during at least two second touch time segments of the plurality of second touch time segments, respectively.

In some embodiments, the one image refresh cycle includes eight of the second touch time segments and four of the first touch time segments, there are two second touch time segments between each two adjacent first touch time segments of the four first touch time segments, the pressure information includes twelve-bit pressure information codes, receiving the pressure information codes of different bits of the multi-bit pressure information codes via the touch sensor during the at least two second touch time segments of the plurality of second touch time segments, respectively, includes: receiving the twelve-bit pressure information codes via the touch sensor during six second touch time segments of the eight second touch time segments, respectively, and receiving two-bit pressure information codes of the twelve-bit pressure information codes via the touch sensor during each of the six second touch time segments, respectively.

In some embodiments, the active object includes a power supply, the touch signal of the active object includes power supply information for indicating a state of the power supply, the power supply information includes multi-bit power supply information codes, wherein sensing the touch signal of the active object via the touch sensor during the plurality of second touch time segments to detect touch of the active object to the touch display device includes: receiving power supply information codes of different bits of the multi-bit power supply information codes via the touch sensor during at least two of the plurality of second touch time segments, respectively.

In some embodiments, the power information includes four-bit power supply information codes, and receiving power supply information codes of different bits of the multi-bit power supply information codes via the touch sensor during at least two of the plurality of second touch time segments, respectively, includes: receiving the four-bit power supply information codes via the touch sensor during four of the eight the second touch time segments, respectively.

In some embodiments, the active object includes a plurality of keys, the touch signal of the active object includes key information for indicating states of the plurality of keys, the key information includes multi-bit key information codes corresponding to the plurality of keys, wherein sensing the touch signal of the active object via the touch sensor during the plurality of second touch time segments to detect touch of the active object to the touch display device includes: receiving key information codes of different bits of the multi-bit key information codes via the touch sensor during at least two of the plurality of second touch time segments, respectively.

In some embodiments, the touch signal of the active object includes hover information for indicating that the active object is in a hover state and identification information for indicating an identification of the active object, the hover information includes a hover information code, the identification information include an identification information code, wherein sensing the touch signal of the active object via the touch sensor during the plurality of second touch time segments to detect touch of the active object to the touch display device includes: receiving the hover information code and the identification information code via the touch sensor during different second touch time segments of the plurality of second touch time segments, respectively.

In some embodiments, the touch signal of the active object includes multi-bit touch signal codes, the multi-bit touch signal codes include at least one of the following: multi-bit pressure information codes, multi-bit power supply information codes, multi-bit key information codes, a hover information code, an identification information code, and a check bit code, wherein sensing the touch signal of the active object via the touch sensor during the plurality of second touch time segments to detect touch of the active object to the touch display device includes: receiving three-to-six-bit of the multi-bit touch signal code via the touch sensor during each of the second touch time segments.

In some embodiments, each touch signal code of the three-to-six-bit touch signal codes includes a multi-bit pulse sequence, and phases of three-to-six-bit pulse sequences of touch signal codes of different bits of the multi-bit touch signal codes are different.

According to a second aspect of the present disclosure, an interaction method between an external object and a touch display device is provided, the touch display device includes a touch sensor, and the interaction method includes the following contents. one image refresh cycle of the touch display device includes a plurality of display driving time segments and a plurality of non-display driving time segments, a display driving time segment and a non-display driving time segment alternate with each other, the plurality of non-display driving time segments include a plurality of first touch time segments and a plurality of second touch time segments, each of the first touch time segments or each of the second touch time segments is one of the non-display driving time segments, respectively, and the one image refresh cycle includes at least two of the second touch time segments located between at least two of the first touch time segments; the external object includes at least one of an active object and a passive object, the touch display device receives a communication signal from the active object, senses a touch signal of the passive object via the touch sensor during the plurality of first touch time segments to detect touch of the passive object to the touch display device, and senses a touch signal of the active object via the touch sensor during the plurality of second touch time segments to detect touch of the active object to the touch display device.

In some embodiments, the one image refresh cycle includes at least two of the second touch time segments located between one group of two adjacent first touch time segments, or the one image refresh cycle includes at least two of the second touch time segments located between two groups of two adjacent first touch time segments, respectively.

In some embodiments, there is at least one second touch time segment between each two adjacent first touch time segments in the one image refresh cycle.

In some embodiments, the one image refresh cycle includes eight second touch time segments and four first touch time segments, there are two second touch time segments between each two adjacent first touch time segments of the four first touch time segments.

In some embodiments, the one image refresh cycle includes six second touch time segments and four first touch time segments, there are two second touch time segments between each two adjacent first touch time segments of the four first touch time segments.

In some embodiments, the one image refresh cycle includes four second touch time segments and four first touch time segments, there is one second touch time segment between each two adjacent first touch time segments of the four first touch time segments.

In some embodiments, the one image refresh cycle includes five second touch time segments and four first touch time segments, there is one second touch time segment between each two adjacent first touch time segments of the four first touch time segments.

In some embodiments, there is no second touch time segment between at least one group of two adjacent first touch time segments in the one image refresh cycle.

In some embodiments, the one image refresh cycle include six second touch time segments and four first touch time segments, there is no second touch time segment between each of two groups of two adjacent first touch time segments of the four first touch time segments, and there is at least two second touch time segments between one group of two adjacent first touch time segments.

In some embodiments, the one image refresh cycle includes six second touch time segments and four first touch time segments, there is no second touch time segment between one group of two adjacent first touch time segments of the four first touch time segments, and there is at least one second touch time segment between each of two groups of two adjacent first touch time segments.

In some embodiments, the plurality of non-display driving time segments in the one image refresh cycle also include a noise processing time segment.

In some embodiments, sums of quantities of first touch time segments and quantities of second touch time segments on two sides of the noise processing time segment are equal.

In some embodiments, the touch display device transmits an uplink signal to the external object, and periodically transmits the uplink signal to the external object with the image refresh cycle of the touch display device as a transmission period, and a time segment corresponding to the uplink signal includes a noise processing time segment.

In some embodiments, detecting touch of the passive object to the touch display device and detecting touch of the active object to the touch display device includes collecting a touch signal of the passive object sensed by the touch sensor and collecting a touch signal of the active object sensed by the touch sensor, respectively, and the method further includes: acquiring a signal-to-noise ratio of at least one of the touch signal of the active object and the touch signal of the passive object during the noise processing time segment; and adjusting a frequency at which the at least one of the touch signal of the active object and the touch signal of the passive object is collected in response to the signal-to-noise ratio being lower than a threshold.

In some embodiments, a time length of each first touch time segment of the plurality of first touch time segments and a time length of each second touch time segment of the plurality of second touch time segments each do not exceed a first threshold.

In some embodiments, the first threshold is 180 microseconds.

In some embodiments, the first touch time segment and the second touch time segment have a same time length.

In some embodiments, the interaction method further includes: if the touch display device does not receive a communication signal from the active object, the touch display device senses the touch signal of the passive object via the touch sensor during the plurality of second touch time segments to detect touch of the passive object to the touch display device.

In some embodiments, the interaction method further includes: if the touch display device does not receive a communication signal from the active object, the touch display device does not detect touch of the active object and the passive object to the touch display device during the plurality of first touch time segments.

In some embodiments, if the touch display device does not receive a communication signal from the active object, the touch display device does not detect touch of the active object and the passive object to the touch display device during two non-display driving time segments of the plurality of non-display driving time segments, and detects a touch signal of the passive object sensed via the touch sensor during other non-display driving time segments other than the two non-display driving time segments of the plurality of non-display driving time segments to detect touch of the passive object to the touch display device.

In some embodiments, the interaction method further includes: if the touch display device does not receive a communication signal from the active object, the touch display device senses the touch signal of the passive object via the touch sensor during the plurality of first touch time segments and the plurality of second touch time segments to detect touch of the passive object to the touch display device.

In some embodiments, the interaction method further includes: the touch display device transmits an uplink signal to the external object, and periodically transmits the uplink signal to the external object with an image refresh cycle of the touch display device as a transmission cycle, wherein the uplink signal includes a first character field, and the first character field is used for characterizing a current image refresh cycle of the touch display device.

In some embodiments, the uplink signal further includes a second character field for characterizing a frequency at which the active object transmits a downlink signal to the touch display device.

In some embodiments, the uplink signal includes 7 bits of data.

In some embodiments, the uplink signal is encoded using Direct Sequence Spread Spectrum, and each bit of data is encoded as a P-bit spread spectrum code sequence, herein, P is a positive integer.

In some embodiments, each bit of data is encoded as a 31-bit spread spectrum code sequence.

In some embodiments, the uplink signal is encoded by Direct Sequence Spread Spectrum and Pseudo-Noise Code corresponding to a current image refresh cycle of the touch display device.

In some embodiments, the touch signal of the active object includes pressure information for indicating a touch pressure of the active object for the touch display device, and the pressure information includes multi-bit pressure information codes. Sensing the touch signal of the active object via the touch sensor during the plurality of second touch time segments to detect touch of the active object to the touch display device includes: receiving pressure information codes of different bits of the multi-bit pressure information codes via the touch sensor during at least two second touch time segments of the plurality of second touch time segments, respectively.

In some embodiments, the one image refresh cycle includes eight of the second touch time segments and four of the first touch time segments, there are two second touch time segments between each two adjacent first touch time segments of the four first touch time segments, the pressure information includes twelve-bit pressure information codes, receiving the pressure information codes of different bits of the multi-bit pressure information codes via the touch sensor during the at least two second touch time segments of the plurality of second touch time segments, respectively, includes: receiving the twelve-bit pressure information codes via the touch sensor during six second touch time segments of the eight second touch time segments, respectively, and receiving two-bit pressure information codes of the twelve-bit pressure information codes via the touch sensor during each of the six second touch time segments, respectively.

In some embodiments, the one image refresh cycle includes six of the second touch time segments and four of the first touch time segments, there are two second touch time segments between each two adjacent first touch time segments of the four first touch time segments, the pressure information includes twelve-bit pressure information codes, receiving the pressure information codes of different bits of the multi-bit pressure information codes via the touch sensor during the at least two second touch time segments of the plurality of second touch time segments, respectively, includes: receiving the six-bit pressure information codes via the touch sensor during two second touch time segments of the six second touch time segments, respectively, and receiving six-bit pressure information codes of the twelve-bit pressure information codes via the touch sensor during each of the two second touch time segments, respectively.

In some embodiments, the active object includes a power supply, the touch signal of the active object includes power supply information for indicating a state of the power supply, the power supply information includes multi-bit power supply information codes, wherein sensing the touch signal of the active object via the touch sensor during the plurality of second touch time segments to detect touch of the active object to the touch display device includes: receiving power supply information codes of different bits of the multi-bit power supply information codes via the touch sensor during at least two of the plurality of second touch time segments or during one of the plurality of second touch time segments, respectively.

In some embodiments, the one image refresh cycle includes eight second touch time segments and four first touch time segments, there are two second touch time segments between each two adjacent first touch time segments of the four first touch time segments. The power information includes four-bit power supply information codes, and receiving power supply information codes of different bits of the multi-bit power supply information codes via the touch sensor during at least two of the plurality of second touch time segments, respectively, includes receiving four-bit power supply information codes via the touch sensor during four of the eight second touch time segments, respectively.

In some embodiments, the one image refresh cycle includes six second touch time segments and four first touch time segments, there are two second touch time segments between each two adjacent first touch time segments of the four first touch time segments. The power information includes eight-bit power supply information codes, and receiving power supply information codes of different bits of the multi-bit power supply information codes via the touch sensor during one of the plurality of second touch time segments, includes receiving eight-bit power supply information codes via the touch sensor during one of the six second touch time segments.

In some embodiments, the active object includes a plurality of keys, the touch signal of the active object includes key information for indicating states of the plurality of keys, the key information includes multi-bit key information codes corresponding to the plurality of keys, wherein sensing the touch signal of the active object via the touch sensor during the plurality of second touch time segments to detect touch of the active object to the touch display device includes: receiving key information codes of different bits of the multi-bit key information codes via the touch sensor during at least two of the plurality of second touch time segments or during one of the plurality of second touch time segments, respectively.

In some embodiments, the touch signal of the active object includes tilt angle information indicating a tilt angle of the active object relative to the touch display device, and the tilt angle information includes multi-bit tilt angle information codes. Sensing the touch signal of the active object via the touch sensor during the plurality of second touch time segments to detect touch of the active object to the touch display device includes: receiving tilt angle information codes of different bits of the multi-bit tilt angle information codes via the touch sensor during at least two second touch time segments of the plurality of second touch time segments, respectively.

In some embodiments, the one image refresh cycle includes eight second touch time segments and four first touch time segments, there are two second touch time segments between each two adjacent first touch time segments of the four first touch time segments. The tilt angle information includes six-bit tilt angle information codes, and receiving tilt angle information codes of different bits of the multi-bit tilt angle information codes via the touch sensor during at least two of the plurality of second touch time segments, respectively, includes receiving six-bit tilt angle information codes via the touch sensor during six of the eight second touch time segments, respectively.

In some embodiments, the one image refresh cycle includes six of the second touch time segments and four of the first touch time segments, there are two second touch time segments between each two adjacent first touch time segments of the four first touch time segments, the tilt angle information includes ten-bit tilt angle information codes, receiving the tilt angle information codes of different bits of the multi-bit tilt angle information codes via the touch sensor during the at least two second touch time segments of the plurality of second touch time segments, respectively, includes: receiving the ten-bit tilt angle information codes via the touch sensor during five second touch time segments of the six second touch time segments, and receiving two-bit tilt angle information codes of the ten-bit tilt angle information codes via the touch sensor during each of the five second touch time segments, respectively.

In some embodiments, the one image refresh cycle includes six of the second touch time segments and four of the first touch time segments, there are two second touch time segments between each two adjacent first touch time segments of the four first touch time segments, the tilt angle information includes eight-bit tilt angle information codes, receiving the tilt angle information codes of different bits of the multi-bit tilt angle information codes via the touch sensor during the at least two second touch time segments of the plurality of second touch time segments, respectively, includes: receiving the eight-bit tilt angle information codes via the touch sensor during four second touch time segments of the six second touch time segments, and receiving two-bit tilt angle information codes of the eight-bit tilt angle information codes via the touch sensor during each of the four second touch time segments, respectively.

In some embodiments, the touch signal of the active object includes hover information for indicating that the active object is in a hover state and identification information for indicating an identification of the active object, the hover information includes a hover information code, the identification information include an identification information code, wherein sensing the touch signal of the active object via the touch sensor during the plurality of second touch time segments to detect touch of the active object to the touch display device includes: receiving the hover information code and the identification information code via the touch sensor during different second touch time segments or a same second touch time segment of the plurality of second touch time segments, respectively.

In some embodiments, the touch signal of the active object includes multi-bit touch signal codes, the multi-bit touch signal codes include at least one of the following: multi-bit pressure information codes, multi-bit power supply information codes, multi-bit key information codes, multi-bit tilt angle information codes, a hover information code, an identification information code, and a check bit code, wherein sensing the touch signal of the active object via the touch sensor during the plurality of second touch time segments to detect touch of the active object to the touch display device includes: receiving three-to-ten-bit of the multi-bit touch signal code via the touch sensor during each of the second touch time segments.

In some embodiments, each touch signal code of the multi-bit touch signal codes includes a multi-bit pulse sequence, and phases of multi-bit pulse sequences of touch signal codes of different bits of the multi-bit touch signal codes are different.

In some embodiments, the touch signal of the active object is encoded based on a Binary Phase Shift Keying (BPSK) format or a Quadrature Phase Shift Keying (QPSK) format.

According to a third aspect of the present disclosure, a touch processor is provided, which includes: a memory configured to store computer-executable instructions; a data processor configured to perform the interaction method according to any of the preceding method embodiments when the computer-executable instructions are executed by the data processor.

According to a fourth aspect of the present disclosure, a computer-readable storage medium is provided, wherein computer-executable instructions are stored on the computer-readable storage medium, and when the computer-executable instructions are executed, an interaction method as described in any one of the preceding method embodiments is performed.

According to a fifth aspect of the present disclosure, a touch display device is provided, which includes a touch sensor and a touch processor, the touch processor is configured to perform an interaction method as described in any one of the preceding method embodiments.

According to a sixth aspect of the present disclosure, a touch system is provided, which includes a touch display device and an active object as described in a preceding embodiment, the active object is configured to transmit a downlink signal to the touch display device in response to receiving an uplink signal, and the active object includes an active pen.

In some embodiments, the active object is also configured to determine a current image refresh cycle of the touch display device according to the uplink signal, and to transmit a downlink signal corresponding to the current image refresh cycle to the touch display device.

According to a seventh aspect of the present disclosure, a computer program product is provided, which includes a computer program that, when executed by a processor, implements an interaction method as described in any one of the foregoing method embodiments.

These and other advantages of the present application will become apparent from embodiments described below, and will be elucidated with reference to the embodiments described below.

### BRIEF DESCRIPTION OF DRAWINGS

Embodiments of the present disclosure will now be described in more detail and with reference to accompanying drawings.

FIG. 1 shows a schematic diagram of touch of an external object to a touch display device.

FIG. 2 shows a block diagram of a touch sensor and a touch processor in a touch display device according to an embodiment of the present disclosure.

FIG. 3 shows a schematic diagram of signal interaction between a touch display device and an active object according to an embodiment of the present disclosure.

FIG. 4 shows a flowchart of an interaction method between an external object and a touch display device according to an embodiment of the present disclosure.

FIG. 5 shows a schematic diagram of timing of display driving time segments and non-display driving time segments during a single image refresh cycle time segment in a case where an active object is sensed by a touch display device according to an embodiment of the present disclosure.

FIG. 6 shows a flowchart of an interaction method between an external object and a touch display device according to another embodiment of the present disclosure.

FIG. 7 shows a schematic diagram of timing of display driving time segments and non-display driving time segments during a single image refresh cycle time segment in a case where an active object is not sensed by a touch display device according to an embodiment of the present disclosure.

FIG. 8 shows a schematic diagram of timing of display driving time segments and non-display driving time segments during a single image refresh cycle time segment in a case where an active object is sensed by a touch display device according to another embodiment of the present disclosure.

FIG. 9 shows a schematic diagram of timing of display driving time segments and non-display driving time segments during a single image refresh cycle time segment in a case where an active object is not sensed by a touch display device according to another embodiment of the present disclosure.

FIG. 10 shows a schematic diagram of timing of display driving time segments and non-display driving time segments during a single image refresh cycle time segment in a case where an active object is sensed by a touch display device according to another embodiment of the present disclosure.

FIG. 11 shows a schematic diagram of timing of display driving time segments and non-display driving time segments during a single image refresh cycle time segment in a case where an active object is not sensed by a touch display device according to another embodiment of the present disclosure.

FIG. 12 shows a schematic diagram of timing of display driving time segments and non-display driving time segments during a single image refresh cycle time segment in a case where an active object is sensed by a touch display device according to another embodiment of the present disclosure.

FIG. 13 shows a schematic diagram of timing of display driving time segments and non-display driving time segments during a single image refresh cycle time segment in a case where an active object is not sensed by a touch display device according to another embodiment of the present disclosure.

FIG. 14 shows a schematic diagram of timing of display driving time segments and non-display driving time segments during a single image refresh cycle time segment in a case where an active object is not sensed by a touch display device according to another embodiment of the present disclosure.

FIG. 15 shows a schematic diagram of timing of display driving time segments and non-display driving time segments during a single image refresh cycle time segment in a case where an active object is sensed by a touch display device according to another embodiment of the present disclosure.

FIG. 16 shows a schematic diagram of timing of display driving time segments and non-display driving time segments during a single image refresh cycle time segment in a case where an active object is sensed by a touch display device according to another embodiment of the present disclosure.

FIG. 17 shows a schematic diagram of timing of display driving time segments and non-display driving time segments during a single image refresh cycle time segment in a case where an active object is sensed by a touch display device according to another embodiment of the present disclosure.

FIG. 18 shows a schematic diagram of timing of display driving time segments and non-display driving time segments during a single image refresh cycle time segment in a case where an active object is sensed by a touch display device according to another embodiment of the present disclosure.

FIG. 19 shows a schematic diagram of timing of display driving time segments and non-display driving time segments during a single image refresh cycle time segment in a case where an active object is sensed by a touch display device according to another embodiment of the present disclosure.

FIG. 20 shows a schematic diagram of timing of display driving time segments and non-display driving time segments during a single image refresh cycle time segment in a case where an active object is sensed by a touch display device according to another embodiment of the present disclosure.

FIG. 21 shows a schematic diagram of timing of display driving time segments and non-display driving time segments during a single image refresh cycle time segment in a case where an active object is sensed by a touch display device according to another embodiment of the present disclosure.

FIG. 22 shows a circuit diagram of modulating and demodulating an uplink signal transmitted by a touch display device to an active object using direct sequence spread spectrum according to an embodiment of the present disclosure.

FIG. 23 shows a schematic diagram of signal codes of an uplink signal transmitted by a touch display device to an active object according to an embodiment of the present disclosure.

FIG. 24 shows a schematic diagram of a pulse sequence of three-bit touch signal codes received via a touch sensor during each second touch time segment according to an embodiment of the present disclosure.

FIG. 25 shows a schematic diagram of a theoretical model of BPSK data according to an embodiment of the present disclosure.

FIG. 26 shows a schematic diagram of a theoretical model of DQPSK data according to an embodiment of the present disclosure.

### DETAILED DESCRIPTION

The following description provides specific details of various embodiments of the present disclosure so that those skilled in the art can fully understand and implement the various embodiments of the present disclosure. In some cases, the present disclosure does not show or describe in detail some structures or functions well known in the art in order to avoid obscuring description of embodiments of the present disclosure by such unnecessary descriptions. Technical solutions of the present patent application may be embodied in many different forms and purposes, and should not be limited to the embodiments set forth herein. These embodiments are provided to make the technical solutions of the present disclosure clear and complete, but the embodiments do not limit protection scope of the present patent application.

In the following description of the present disclosure, detailed descriptions of known functions and configurations contained herein will be omitted when they may obscure rather than make the subject matter of the present disclosure clear. In addition, terms such as “first” and “second” mentioned herein are merely used to distinguish respective elements from other elements, and a nature, order, precedence, or quantity of the respective elements are not limited by these terms. When a certain element is described as “connected” or “linked” to another element, it should be understood that the element may not only be “connected” or “linked” to another element directly, but may also be “connected” or “linked” to another element through a third element, or the third element may also be interposed between the certain element and the another element.

An embodiment of the present disclosure provides an interaction method between an external object and a touch display device. The “touch display device” referred to herein refers to an electronic device having a touch function and an image display function, and a user may achieve desired control of the device by touching a certain position or certain positions on a display screen of the electronic device. Examples of the touch display device includes, but are not limited to, a liquid crystal display, an organic light emitting diode display, a plasma display, and the like.

The “external object” referred to herein is described relative to the “touch display device”, that is, the external object does not belong to the touch display device. The external object refers to an object that can touch a screen of the touch display device while the touch display device is running and can be recognized by the touch display device. The external object includes a finger or other body part of a user, and may also include other touch tools that can be recognized by the touch display device, examples of the touch tools include, but are not limited to, a touch pen, a handwriting pen, an active pen, a stylus, a touch stick, and the like. In an embodiment of the present disclosure, the external object is distinguished into an active object and a passive object. The active object refers to a touch tool capable of receiving and transmitting signals, and the active object typically carries a power supply element itself, such as a battery. Examples of the active object include, but are not limited to, an active pen. The passive object includes a touch tool that does not have a signal transmission/reception function, examples of the passive object include, but are not limited to, a stylus, a touch stick, etc. that does not have a signal transmission/reception function, and herein, a user's finger or other body parts capable of performing a touch operation on the touch display device is also classified as a passive object.

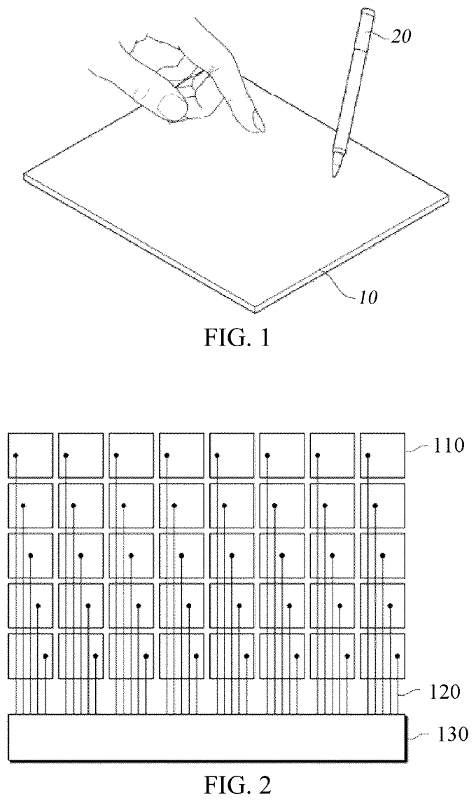

FIG. 1 shows a schematic diagram of touch of an external object to a touch display device, and the external object and the touch display device may constitute a touch system. As shown in FIG. 1, both an active pen 20 and a user's finger may perform a touch operation on a display screen of a touch display device 10 to achieve a desired operation on the touch display device by the user.

In some embodiments, the touch display device may include a touch sensor, touch of an external object to the touch display device may cause a change in an electrical signal on the touch sensor, and the touch display device may determine whether the external object touches the touch display device and a specific touch position according to the change in the electrical signal on the touch sensor. For example, the touch display device may implement detection of touch of the external object based on a mutual capacitive touch sensing principle or a self-capacitive touch sensing principle. FIG. 2 shows a block diagram of a touch sensor and a touch processor in a touch display device based on the self-capacitive touch sensing principle. As shown in FIG. 2, the touch sensor may include a plurality of touch electrodes 110, and the touch electrodes 110 may form a touch electrode array, and a layer structure where the touch electrodes are located may be referred to as a touch electrode layer. FIG. 2 also shows a touch processor 130, and the touch processor 130 is electrically connected with the plurality of touch electrodes 110 in the touch sensor via a plurality of signal lines 120 respectively. The touch processor 130 may apply a touch drive signal to each of the touch electrodes 110, and may receive a touch sensing signal from the touch electrodes 110. When an external object touches the touch display device, an electrical signal on at least a part of the touch electrodes (e.g., a touch electrode corresponding to a touch position of the external object on the screen of the touch display device) may change, for example, a capacitance value of self-capacitance of the above-described at least part of the touch electrodes may change due to touch of the external object. The touch processor 130 receives a touch sensing signal indicating a change in the capacitance value via a signal line 120, and determines that a touch event by the external object for the touch display device has occurred according to the touch sensing signal, and determines a specific touch position. In some other embodiments, the touch display device may also detect touch of an external object based on the mutual capacitance touch sensing principle, in this case, the touch sensor may include a plurality of touch drive electrodes and a plurality of touch sensing electrodes, and the touch processor 130 may detect touch of the external object based on a change in mutual capacitance between a touch drive electrode and a touch sensing electrode. That is, the touch sensor in the touch display device based on the self-capacitive touch sensing principle shown in FIG. 2 does not limit the interaction method between the external object and the touch display device proposed in the embodiment of the present disclosure, in other words, the interaction method between the external object and the touch display device proposed in the embodiment of the present disclosure may also be applied to a touch display device based on the mutual capacitive touch sensing principle.

The touch display device includes a display panel having an image function, the touch sensor described above may be fabricated outside the display panel, and in some embodiments, a touch panel including a touch sensor and a touch processor may be fabricated, and the touch panel and the display panel are combined to form the touch display device. In some other embodiments, the touch sensor may also be fabricated inside the display panel, i.e., the touch sensor may be embedded in the display panel. When the touch sensor is embedded in the display panel, the touch sensor may be formed together with an electrode or a signal line related to display drive in the display panel during manufacturing the display panel. For example, if the touch display device is implemented as a liquid crystal display, a common electrode in the liquid crystal display may be fabricated into a plurality of common electrode blocks and reused as the touch sensor. A common electrode performs different functions at different time segments. For example, a common voltage may be applied to each common electrode block during a time segment in which the touch display device is driven to display an image, and a touch drive signal may be applied to a common electrode block or a touch sensing signal may be received from the common electrode block during a time segment in which touch of the external object to the touch display device is detected. In a case where the touch display device is implemented as an organic light-emitting diode display, the touch sensor may be formed on a surface of the organic light-emitting diode display panel, for example, on an encapsulation layer of the organic light-emitting diode display panel.

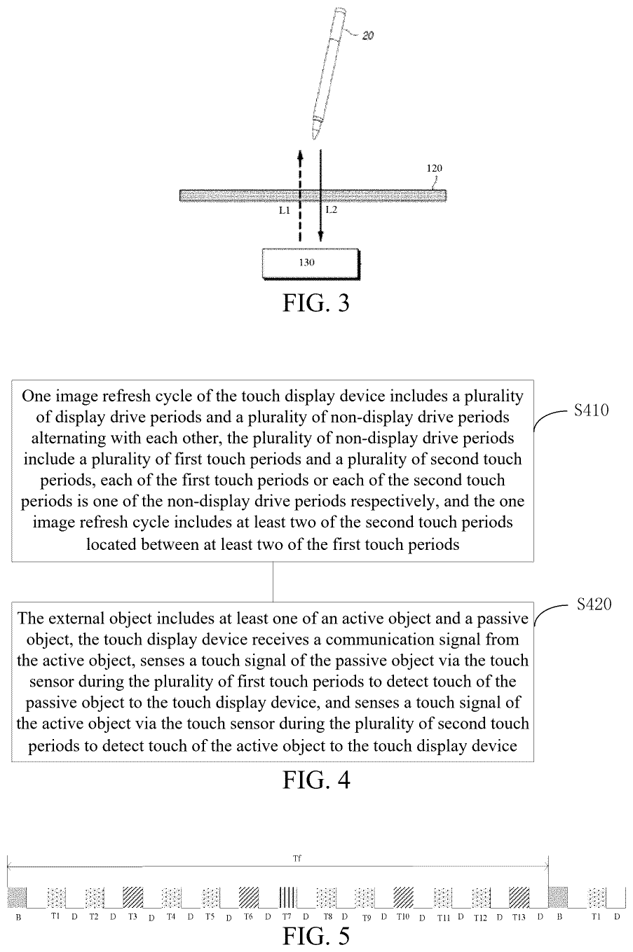

FIG. 3 shows a schematic diagram of signal interaction between a touch processor 130 and an active object (active pen 20) in a touch display device. As shown in FIG. 3, the touch processor 130 may transmit a signal to or receive a signal from the active pen 20 via a touch sensor 120. Paths through which the touch processor 130 transmits a signal to the active pen 20 and receives a signal from the active pen 20 are illustrated as L1 and L2 respectively, in FIG. 3. A signal transmitted by the touch processor 130 to the active object 20 via the touch sensor 120 is referred to herein as an uplink signal, and a signal transmitted by the active object 20 to the touch processor 130 via the touch sensor 120 is referred to herein as a downlink signal.

The touch processor 130 may be implemented as a single or multiple integrated circuit chips. According to an embodiment of the present disclosure, the touch processor includes a sensing driver and a touch controller, and the sensing driver is electrically connected with the touch sensor to sense a change in an electrical signal (e.g., a capacitance value of a self-capacitance) on the touch sensor, so that it is possible to determine whether an external object touches the touch display device or not. The touch controller is electrically connected with the sensing driver and may receive a downlink signal transmitted by the active object, the touch controller further determines a touch state (for example, a touch position, a Pressure sensitivity (Pressure), a Tilt angle (Tilt), a battery Power (Power), etc. of the external object.) related to the external object based on the change in the electrical signal on the touch sensor sensed by the sensing driver or based on the downlink signal transmitted by the active object. In FIG. 2 and FIG. 3, the touch processor 130 is illustrated as a single integrated circuit chip, and in some other embodiments, different functional modules in the touch processor 130 may be respectively implemented as independent integrated circuit chips, for example, the sensor driver and the touch controller may be implemented as different integrated circuit chips, respectively.

Hereinafter, the interaction method between the external object and the touch display device according to the embodiment of the present disclosure will be described with reference to FIG. 4. As shown in FIG. 4, the method includes the following steps: S410, one image refresh cycle of the touch display device includes a plurality of display driving time segments and a plurality of non-display driving time segments, wherein the display driving time segment and the non-display driving time segment alternate with each other, the plurality of non-display driving time segments include a plurality of first touch time segments and a plurality of second touch time segments, each of the first touch time segments or each of the second touch time segments is one of the non-display driving time segments respectively, and the one image refresh cycle includes at least two second touch time segments located between at least two first touch time segments; S420, the external object includes at least one of an active object and a passive object, the touch display device receives a communication signal from the active object, senses a touch signal of the passive object via the touch sensor during the plurality of first touch time segments to detect touch of the passive object to the touch display device, and senses a touch signal of the active object via the touch sensor during the plurality of second touch time segments to detect touch of the active object to the touch display device. The image refresh cycle mentioned herein refers to a time segment during which the touch display device displays one frame of image. The image refresh cycle corresponds to an image refresh frequency, for example, when image refresh frequencies of the touch display device are 60 Hz, 90 Hz, 120 Hz, and 144 Hz respectively, image refresh cycles are 1/60 second, 1/90 second, 1/120 second, and 1/144 second respectively. In addition, the expression “one image refresh cycle includes at least two second touch time segments located between at least two first touch time segments” in the above step S410 does not limit a specific arrangement of the at least two second touch time segments between the at least two first touch time segments. In some embodiments, one image refresh cycle may include at least two second touch time segments located between one group of two adjacent first touch time segments, e.g., two second touch time segments located between one group of two adjacent first touch time segments; or one image refresh cycle includes at least two second touch time segments located between two groups of two adjacent first touch time segments respectively, for example, one second touch time segment located between one group of two adjacent first touch time segments and the other second touch time segment located between the other group of two adjacent first touch time segments. This will be further described below by way of example.

The interaction method between the external object and the touch display device proposed in the embodiment described above of the present disclosure may be periodically executed according to an image refresh cycle of the touch display device. FIG. 5 is a schematic diagram of timing of display driving time segments and non-display driving time segments (including a first touch time segment and a second touch time segment) during a time segment of a single image refresh cycle Tf in a case where a touch display device senses an active object. In some embodiments, the touch display device may transmit an uplink signal to the external object to establish a connection between the external object and the touch display device. In FIG. 5, a time segment in which the touch display device transmits an uplink signal to the external object is identified as B, and the image refresh cycle Tf may also be understood as a transmission period in which the touch display device transmits the uplink signal to the external object.

As shown in FIG. 5, the touch display device transmits the uplink signal to the external object during the time segment B, and if the touch display device receives a communication signal (e.g., an Acknowledgement character (ACK) signal or the like) from the external object, it indicates that the touch display device discovers an active object (e.g., an active pen) and establishes a connection with the active object. A time segment in which the touch display device displays one frame of image (i.e., an image refresh cycle) includes a plurality of display driving time segments D and a plurality of non-display driving time segments, the display driving time segments and the non-display driving time segments alternate with each other, and the plurality of non-display driving time segments may include a plurality of first touch time segments T3, T6, T10, T13 and a plurality of second touch time segments T1, T2, T4, T5, T8, T9, T11, T12. Each of the first touch time segments or each of the second touch time segments is one of the non-display driving time segments respectively. As shown in FIG. 5, a single image refresh cycle includes at least two second touch time segments (e.g., second touch time segments T4, T5) located between one group of two adjacent first touch time segments (e.g., first touch time segments T3, T6). In this example, there is only a display driving time segment D between the above-described at least two second touch time segments (e.g., the second touch time segments T4, T5). During each display driving time segment D, each pixel of the touch display device is driven by a pixel drive circuit and a gate scan circuit of the touch display device to display an image. During the plurality of first touch time segments T3, T6, T10, and T13, a touch signal of a passive object is sensed via a touch sensor to detect touch of the passive object to the touch display device. If a passive object (e.g., a user's finger) touches the touch display device, the passive object may affect an electrical signal on the touch sensor, e.g., a change in electric charges on the touch electrode causes a change in self-capacitance of a touch electrode, a change in the electrical signal on the touch sensor may be regarded as a touch signal of the passive object, and the touch processor may collect the touch signal to detect touch of the passive object to the touch display device, e.g., determine a touch position of the passive object, etc. If no passive object touches the touch display device, the electrical signal on the touch sensor does not change during the first touch time segments T3, T6, T10, and T13, and the touch processor determines that no passive object is detected. That is, during a time segment Tf in which each frame of image is displayed, the touch processor of the touch display device detects touch of the passive object to the touch display device during the first touch time segments T3, T6, T10, and T13. During the plurality of second touch time segments T1, T2, T4, T5, T8, T9, T11, and T12, the touch display device senses a touch signal of the active object via the touch sensor to detect touch of the active object to the touch display device. If an active object (e.g., an active pen) touches the touch display device, the active object causes a change in the electrical signal on the touch sensor, while the active object may also send a downlink signal to the touch display device, and the touch processor receives the downlink signal via the touch sensor, thereby determining not only a touch position of the active object, but also other touch states related to the active object, e.g., a touch pressure, a posture of the active object, etc. It should be noted that touch of the at least one of the passive object and the active object to the touch display device may be direct contact or indirect contact in a floating manner within a distance at which the touch display device can detect the at least one of the passive object and the active object, and a specific contact form is not limited in the present disclosure.

With the timing arrangement of the display driving time segment, the first touch time segment, and the second touch time segment during the image refresh cycle, compared with an interaction method between an external object and a touch display device realized based on a conventional communication protocol between the external object and the touch display device, a proportion occupied by a total time length of the first touch time segments and the second touch time segments in the image refresh cycle may be reduced without affecting detection of touch of the active object and the passive object, so that each image refresh cycle includes a longer display driving time segment, which is very beneficial to further improving image display quality of the touch display device, for example, an implementation of the touch display device with higher image refresh rate and higher pixels per inch (PPI) may be supported.

In some embodiments, there is at least one second touch time segment between every two adjacent first touch time segments in one image refresh cycle. As shown in FIG. 5, there are two second touch time segments among the second touch time segments T1, T2, T4, T5, T8, T9, T11, and T12 between every two adjacent first touch time segments among the first touch time segments T3, T6, T10, and T13. For example, there are second touch time segments T4 and T5 between the first touch time segments T3 and T6, there are second touch time segments T8 and T9 between the first touch time segments T6 and T10, and there are second touch time segments T11 and T12 between the first touch time segments T10 and T13. In the embodiment shown in FIG. 5, the image refresh cycle Tf includes eight second touch time segments and four first touch time segments, and there are two second touch time segments between every two adjacent first touch time segments. The image refresh cycle Tf further includes thirteen display driving time segments D. The image refresh frequency of the touch display device may be 60 Hz or 90 Hz, and the image refresh cycle Tf shown in FIG. 5 in this case is 1/60 second or 1/90 second, respectively. Even if an active object such as an active pen and a user's finger simultaneously touch the touch display device, the touch display device may detect touch of both the active pen and the finger to the touch display device during each image refresh cycle Tf.

There may be differences in information contained in the touch signal of the passive object and the touch signal of the active object mentioned herein and in the following description. The touch signal of the passive object includes a change in electrical signal on the touch sensor caused by the passive object touching the touch display device, and the touch signal of the active object includes a downlink signal transmitted by the active object to the touch display device in addition to a change in electrical signal on the touch sensor caused by the active object touching the touch display device.

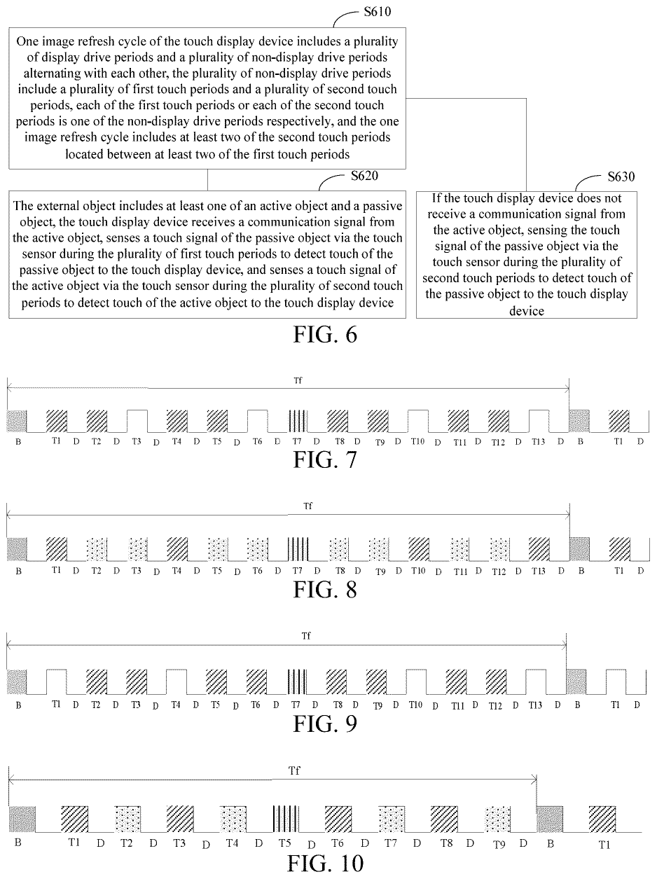

According to another embodiment of the present disclosure, as shown in FIG. 6, the interaction method of the external object and the touch display device further includes: S630, if the touch display device does not receive a communication signal from the active object, the touch signal of the passive object sensed via the touch sensor during the plurality of second touch time segments to detect touch of the passive object to the touch display device. Steps S610 and S620 shown in FIG. 6 are the same as the steps S410 and S420 shown in FIG. 4, which will not be repeatedly herein. If the touch display device does not receive a communication signal from the active object, during the plurality of first touch time segments, although both the active object and the passive object may touch the touch display device, touch of the active object and the passive object to the touch display device is not detected. Referring next to FIG. 7, in a case where the touch display device does not receive a communication signal from an external object, the touch display device determines that there is no active object in the vicinity, and senses a touch signal of the passive object via the touch sensor during the second touch time segments T1, T2, T4, T5, T8, T9, T11, and T12 described above to detect touch of the passive object to the touch display device. If the passive object (e.g., a user's finger) touches the touch display device, an electrical signal on the touch sensor changes, thereby obtaining a touch signal of the passive object, the touch processor detects touch of the passive object to the touch display device based on the touch signal. If no passive object touches the touch display device, the electrical signal on the touch sensor does not change during the second touch time segments T1, T2, T4, T5, T8, T9, T11, and T12, and the touch display device determines that no passive object is detected. That is, in this embodiment, if the touch display device determines that there is no active object in the vicinity thereof, it is detected whether a passive object touches the touch display device during each of the second touch time segments described above. While during the first touch time segments T3, T6, T10, and T13 shown in FIG. 7, the touch display device does not detect touch of the external object (including the active object and the passive object), thereby reducing a load on the touch processor and reducing power consumption of the touch display device.

In some other embodiments, in a case where the touch display device does not receive a communication signal from the active object, at least a part of the plurality of first touch time segments T3, T6, T10, and T13 may be used as a noise processing time segment, in this case, the interaction method between the external object and the touch display device further includes: acquiring a signal-to-noise ratio of at least one of the touch signal of the active object and the touch signal of the passive object during the noise processing time segment; and in response to the signal-to-noise ratio being lower than a threshold, adjusting a frequency of at which the at least one of the touch signal of the active object and the touch signal of the passive object is collected.

FIG. 8 shows a schematic diagram of timing of display driving time segments, first touch time segments, and second touch time segments during a single image refresh cycle Tf time segment of a touch display device according to another embodiment of the present disclosure. As shown in FIG. 8, the image refresh cycle Tf includes thirteen display driving time segments D for image display, eight second touch time segments (T2, T3, T5, T6, T8, T9, T11, and T12), and four first touch time segments (T1, T4, T10, and T13). One image refresh cycle Tf includes at least two second touch time segments (e.g., T5, T6, T8, and T9) located between one group of two adjacent first touch time segments (e.g., T4 and T10). There are two second touch time segments T2 and T3 between adjacent first touch time segments T1 and T4, there are four second touch time segments T5, T6, T8, and T9 between adjacent first touch time segments T4 and T10, and there are two second touch time segments T11 and T12 between adjacent first touch time segments T10 and T13. For the embodiment shown in FIG. 8, the touch display device sends an uplink signal to an external object during a time segment B, if the touch display device receives a communication signal from the external object, it is indicated that the touch display device senses the presence of an active object. During the second touch time segments T2, T3, T5, T6, T8, T9, T11, and T12, a touch signal of the active object is sensed via the touch sensor to detect touch of the active object to the touch display device, and during the first touch time segments T1, T4, T10, and T13, a touch signal of the passive object is sensed via the touch sensor to detect touch of the passive object to the touch display device. As shown in FIG. 9, if the touch display device does not receive a communication signal from an external object, it indicates that the touch display device does not sense an active object. During the second touch time segments T2, T3, T5, T6, T8, T9, T11, and T12, a touch signal of the passive object is sensed via the touch sensor to detect touch of the passive object to the touch display device. While during the first touch time segments T1, T4, T10, and T13, the touch display device does not detect touch of the external object.

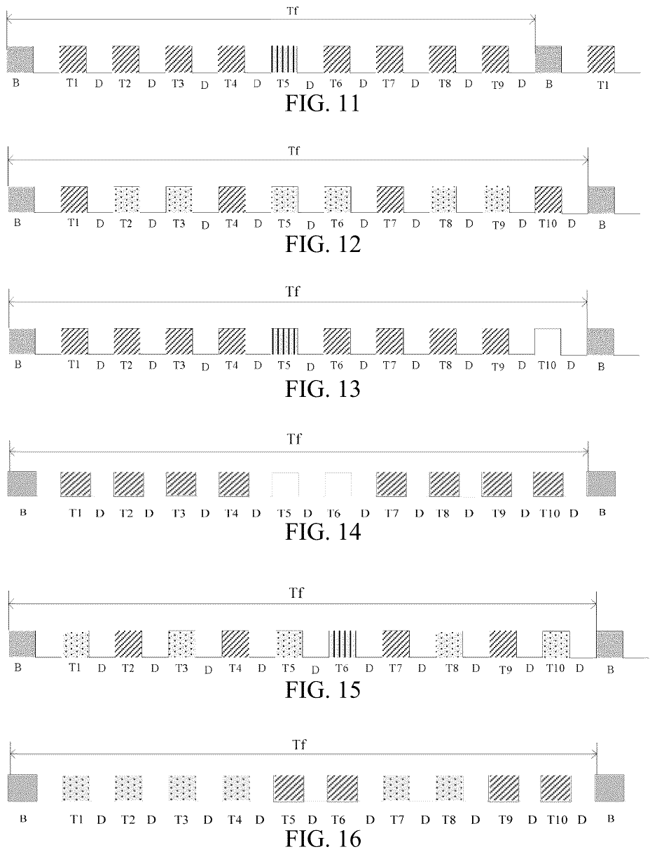

FIG. 10 shows a schematic diagram of timing of display driving time segments, first touch time segments, and second touch time segments during a single image refresh cycle Tf time segment of a touch display device according to another embodiment of the present disclosure. In this embodiment, the image refresh cycle Tf includes four second touch time segments T2, T4, T7, T9 and four first touch time segments T1, T3, T6, T8, and one image refresh cycle Tf includes at least two second touch time segments located between two groups of two adjacent first touch time segments respectively. In this example, a first touch time segment is also included between the at least two second touch time segments described above. For example, a second touch time segment T2 is located between two adjacent first touch time segments T1 and T3, a second touch time segment T4 is located between two adjacent first touch time segments T3 and T6, and a second touch time segment T7 is located between two adjacent first touch time segments T6 and T8. Furthermore, there is one second touch time segment between each two adjacent first touch time segments of the four first touch time segments. For example, there is the second touch time segment T2 between the first touch time segments T1 and T3, the second touch time segment T4 between the first touch time segments T3 and T6, and the second touch time segment T7 between the first touch time segments T6 and T8. In the embodiment of FIG. 10, an image refresh frequency of the touch display device is 90 Hz or higher. The touch display device sends an uplink signal to an external object during a time segment B, if the touch display device receives a communication signal from the external object, it is indicated that the touch display device senses the presence of an active object. During the second touch time segments T2, T4, T7, and T9, a touch signal of the active object is sensed via the touch sensor to detect touch of the active object to the touch display device, and during the first touch time segments T1, T3, T6, and T8, a touch signal of the passive object is sensed via the touch sensor to detect touch of the passive object to the touch display device. As shown in FIG. 11, if the touch display device does not receive a communication signal from an external object, it indicates that the touch display device does not sense an active object. During the second touch time segments T2, T4, T7, T9 and the first touch time segments T1, T3, T6, T8, a touch signal of a passive object is received via the touch sensor to sense touch of the passive object to the touch display device.

In some embodiments, detecting touch of the passive object to the touch display device and detecting touch of the active object to the touch display device includes collecting a touch signal of the passive object sensed by the touch sensor and collecting a touch signal of the active object sensed by the touch sensor respectively, e.g., the touch processor may collect a change in an electrical signal on the touch sensor and a downlink signal transmitted by the active object. The plurality of non-display driving time segments further include a noise processing time segment, in this case, the interaction method between the external object and the touch display device further includes the steps of: acquiring a signal-to-noise ratio of at least one of a touch signal of the active object and a touch signal of the passive object during the noise processing time segment; and in response to the signal-to-noise ratio being lower than a threshold, adjusting a frequency at which the at least one of the touch signal of the active object and the touch signal of the passive object is collected. Referring back to FIGS. 5, 7 to 9, during each image refresh cycle Tf, the plurality of non-display driving time segments further include a noise processing time segment T7. During the noise processing time segment T7, a controller (e.g., a touch processor) in the touch display device may calculate a signal-to-noise ratio of at least one of a touch signal of an active object and a touch signal of a passive object. The at least one of the touch signal of the active object and the touch signal of the passive object may include an interference signal, which may originate from the touch display device itself or from a surrounding environment. If the signal-to-noise ratio of the at least one of the touch signal of the active object and the touch signal of the passive object is lower than a threshold, the frequency of collecting the touch signal of the active object or the frequency of collecting the touch signal of the passive object is adjusted. In some embodiments, the frequency (which may be simply referred to as a sampling frequency) at which the touch signal of the at least one of the active object and the passive object is collected is between 200 KHz and 400 KHz. When the signal-to-noise ratio of the at least one of the touch signal of the active object and the touch signal of the passive object is lower than a threshold, a frequency at which the touch signal of the at least one of the active object and the passive object is collected is adjusted so that the sampling frequency avoids the frequency of the interference signal, thereby reducing influence of the interference signal on detecting touch of the external object to the touch display device.

In FIGS. 10 and 11, the noise processing time segment is identified as T5. In some other embodiments, if the signal-to-noise ratio of the at least one of the touch signal of the active object and the touch signal of the passive object is lower than the threshold, the frequency at which the active object transmits the downlink signal to the touch display device may also be adjusted, thereby further reducing the influence of the interference signal on detecting touch of the external object to the touch display device.

In some embodiments, neither of a time length of each first touch time segment of the plurality of first touch time segments and a time length of each second touch time segment of the plurality of second touch time segments exceeds a first threshold.

It may be understood that a frequency of the downlink signal is usually between 100 KHz and 400 KHz, and the frequency may be adjusted according to a specific case. Each second touch time segment needs to complete signal transmission of 41 to 91 square waves with a frequency of 100 KHz to 400 KHz, and the time length thereof does not exceed a first threshold, and the first threshold may be determined according to performance of a screen of the touch display device to avoid abnormal display of the screen. In some embodiments, a maximum value of the first threshold is 180 microseconds, for example, may be 140 microseconds, 180 microseconds, or the like.

In some embodiments, the first touch time segments and the second touch time segments may have a same time length. Referring to FIGS. 5 and 7, durations of the first touch time segments T3, T6, T10, T13 and durations of the second touch time segments T1, T2, T4, T5, T8, T9, T11, T12 are the same. In FIGS. 8 and 9, the eight second touch time segments T2, T3, T5, T6, T8, T9, T11, and T12 and the four first touch time segments T1, T4, T10, and T13 also have a same time length. In some embodiments, the noise processing time segment T7 does not exceed a second threshold, the second threshold may satisfy a time required for noise detection, for example, the noise processing time segment T7 does not exceed 180 microseconds. In some other embodiments, the noise processing time segment T7 described above has a same time length as that of each of the first touch time segments or the second touch time segments. For the embodiments of FIGS. 10 and 11, the second touch time segments T2, T4, T7, T9, the first touch time segments T1, T3, T6, T8, and the noise processing time segment T5 may have a same time length.

In some embodiments, the plurality of first touch time segments and the plurality of second touch time segments are distributed on two sides of the noise processing time segment in a time-length symmetrical manner, i.e., sums of quantities of first touch time segments and quantities of second touch time segments on two sides of the noise processing time segment are equal. This means that overall durations of the first touch time segments and the second touch time segments on two sides of the noise processing time segment are the same during each image refresh cycle or a time segment of displaying each image frame. When each touch time segment and each second touch time segment have a same time length, total quantities of the first touch time segments and the second touch time segments on two sides of the noise processing time segment are the same. For example, as shown in FIG. 5, the second touch time segments T1, T2, T4, T5, the first touch time segments T3, T6 and the second touch time segments T8, T9, T11, T12, the first touch time segments T10, T13 are distributed on two sides of the noise processing time segment T7 in a time-length symmetrical manner, before the noise processing time segment T7, there are six time segments, that is, the second touch time segments T1, T2, T4, T5, and the first touch time segments T3, T6, and after the noise processing time segment T7, there are also six time segments, that is, the second touch time segments T8, T9, T11, T12, and the first touch time segments T10, T13. Similarly, as shown in FIG. 10, the first touch time segments T1, T3, T6, T8, and the second touch time segments T2, T4, T7, and T9 are distributed on two sides of the noise processing time segment T5 in a time-length symmetrical manner. However, the technical solution of the present disclosure is not limited thereto, and in some other embodiments, a position of the noise processing time segment may be exchanged with that of any one of the first touch time segments or any of the second touch time segments in time, and in this case, the plurality of first touch time segments and the plurality of second touch time segments are distributed on two sides of the noise processing time segment in a time-length asymmetrical manner. In some other embodiments, a time length of the noise processing time segment may be different from a time length of a first touch time segment or a second touch time segment.

FIG. 12 shows a schematic diagram of timing of display driving time segments and non-display driving time segment during a single image refresh cycle time segment in a case where an active object is sensed by a touch display device according to another embodiment of the present disclosure. In the example of FIG. 12, one image refresh cycle includes six second touch time segments T2, T3, T5, T6, T8, T9 and four first touch time segments T1, T4, T7, and T10, and one image refresh cycle Tf includes at least two second touch time segments located between one group of two adjacent first touch time segments (e.g., first touch time segments T1 and T4), and there are two second touch time segments between each two adjacent first touch time segments of the four first touch time segments T1, T4, T7, and T10. One image refresh cycle further includes ten display driving time segments D. An image refresh frequency of the touch display device may be 120 Hz, in this case the image refresh cycle Tf shown in FIG. 12 is 1/120 second. In the example of FIG. 12, the touch display device transmits an uplink signal to an external object during a time segment B, a transmission period of the uplink signal is the image refresh cycle, and a time segment (that is, the time segment B) corresponding to the uplink signal may include a noise processing time segment, that is, noise processing may be implemented during the time segment B to reduce influence of an interference signal on detecting touch of the external object to the touch display device.

FIG. 13 is shows a schematic diagram of timing of display driving time segments and non-display driving time segments during a single image refresh cycle time segment in a case where no active object is sensed by the touch display device of the embodiment illustrated in FIG. 12. As shown in FIG. 13, in a case where the touch display device does not sense an active object, the touch display device does not detect touch of the active object and the passive object to the touch display device during two non-display driving time segments (e.g., T5 and T10) of the plurality of non-display driving time segments, while during other non-display driving time segments (e.g., during the second touch time segments T2, T3, T6, T8, T9 and during the first touch time segments T1, T4, T7), a touch signal of the passive object is received via the touch sensor to sense touch of the passive object to the touch display device, thereby reducing a load on the touch processor and reducing power consumption of the touch display device. In the example shown in FIG. 13, the non-display driving time segment T5 may also be used for noise processing. In some other embodiments, the touch display device may also sense a touch signal of the passive object via the touch sensor during all six second touch time segments T2, T3, T5, T6, T8, T9 and four first touch time segments T1, T4, T7, and T10 to detect touch of the passive object to the touch display device.

As shown in FIG. 14, in a case where the touch display device does not sense an active object, the touch display device does not detect touch of the active object and the passive object to the touch display device during two non-display driving time segments (e.g., T5 and T6) of the plurality of non-display driving time segments, while during other non-display driving time segments (e.g., T1, T2, T3, T4, T7, T8, T9, and T10), a touch signal of the passive object is received via the touch sensor to sense touch of the passive object to the touch display device. In the example of FIG. 14, the non-display driving time segments do not include a noise processing time segment.

FIG. 15 shows a schematic diagram of timing of display driving time segments and non-display driving time segments during a single image refresh cycle time segment in a case where an active object is sensed by a touch display device according to another embodiment of the present disclosure. In this example, one image refresh cycle includes five second touch time segments T1, T3, T5, T8, and T10 and four first touch time segments T2, T4, T7, and T9, and there is one second touch time segment between each two adjacent first touch time segments of the four first touch time segments T2, T4, T7, and T9. One image refresh cycle Tf includes at least two second touch time segments located between two groups of two adjacent first touch time segments respectively. For example, the second touch time segment T3 is located between two adjacent first touch time segments T2, T4, the second touch time segment T5 is located between two adjacent first touch time segments T4, T7, and the second touch time segment T8 is located between two adjacent first touch time segments T7, T9. In FIG. 15, a noise processing time segment is identified as T6.

In some embodiments, there is no second touch time segment between at least one group of two adjacent first touch time segments in one image refresh cycle. That is, in one image refresh cycle, there may be one group of two adjacent first touch time segments without a second touch time segment located therebetween, or there may be a plurality of groups of two adjacent first touch time segments without a second touch time segment located therebetween.

In an implementation process, one image refresh cycle may include six second touch time segments and four first touch time segments, there is no second touch time segment between each of two groups of two adjacent first touch time segments of the four first touch time segments, and there are at least two second touch time segments between one group of two adjacent first touch time segments. That is, in this case, there may be two, three, or more second touch time segments between one group of two adjacent first touch time segments. FIG. 16 shows a schematic diagram of timing of display driving time segments and non-display driving time segments during a single image refresh cycle time segment in a case where an active object is sensed by a touch display device according to another embodiment of the present disclosure. In this example, one image refresh cycle includes six second touch time segments T1, T2, T3, T4, T7, T8 and four first touch time segments T5, T6, T9, T10, there is no second touch time segment between each of two groups of two adjacent first touch time segments of the four first touch time segments, and there is two second touch time segments between one group of two adjacent first touch time segments. For example, there is no second touch time segment between two adjacent first touch time segments T5 and T6, and between two adjacent first touch time segments T9 and T10, and there are two second touch time segments T7 and T8 between two adjacent first touch time segments T6 and T9.

In an implementation process, one image refresh cycle may also include six second touch time segments and four first touch time segments, there is no second touch time segment between one group of two adjacent first touch time segments of the four first touch time segments, and there is at least one second touch time segment between each of two groups of two adjacent first touch time segments. That is, in this case, there is one, two or more second touch time segments between each of two groups of two adjacent first touch time segments.

FIG. 17 shows a schematic diagram of timing of display driving time segments and non-display driving time segments during a single image refresh cycle time segment in a case where an active object is sensed by a touch display device according to another embodiment of the present disclosure. In this example, one image refresh cycle includes six second touch time segments T1, T2, T3, T4, T6, and T8 and four first touch time segments T5, T7, T9, and T10, among the four first touch time segments, there is no second touch time segment between one group of two adjacent first touch time segments, and there is one second touch time segment between each of two groups of two adjacent first touch time segments. For example, there is no second touch time segment between two adjacent first touch time segments T9 and T10, and there is one second touch time segment T6 between two adjacent first touch time segments T5 and T7, and there is one second touch time segment T8 between two adjacent first touch time segments T7 and T9. The two adjacent first touch time segments T5 and T7 are one group of the two groups of two adjacent first touch time segments, the two adjacent first touch time segments T7 and T9 are the other group of the two groups of two adjacent first touch time segments, and the two groups of two adjacent first touch time segments share the first touch time segment T7.

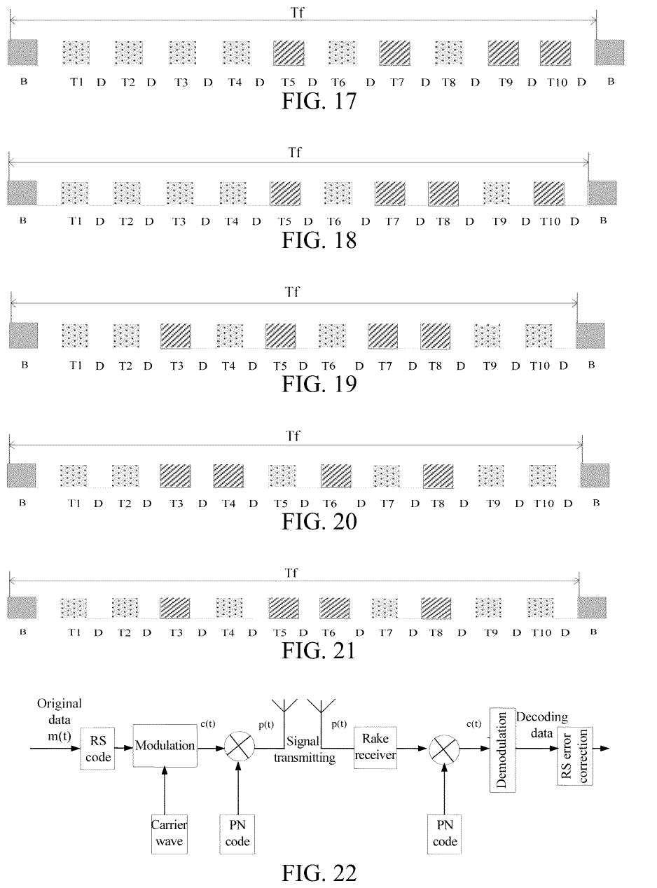

FIG. 18 shows a schematic diagram of timing of display driving time segments and non-display driving time segments during a single image refresh cycle time segment in a case where an active object is sensed by a touch display device according to another embodiment of the present disclosure. In this example, one image refresh cycle includes six second touch time segments T1, T2, T3, T4, T6, T9 and four first touch time segments T5, T7, T8, T10, among the four first touch time segments, there is no second touch time segment between one group of two adjacent first touch time segments, and there is one second touch time segment between each of two groups of two adjacent first touch time segments. For example, there is no second touch time segment between two adjacent first touch time segments T7 and T8, and there is one second touch time segment T6 between two adjacent first touch time segments T5 and T7, and there is one second touch time segment T9 between two adjacent first touch time segments T8 and T10. The two adjacent first touch time segments T5 and T7 are one group of the two groups of two adjacent first touch time segments, the two adjacent first touch time segments T8 and T10 are the other group of the two groups of two adjacent first touch time segments, and there is no shared first touch time segment between the two groups of two adjacent first touch time segments.

FIG. 19 shows a schematic diagram of timing of display driving time segments and non-display driving time segments during a single image refresh cycle time segment in a case where an active object is sensed by a touch display device according to another embodiment of the present disclosure. In this example, one image refresh cycle includes six second touch time segments T1, T2, T4, T6, T9, and T10 and four first touch time segments T3, T5, T7, and T8, among the four first touch time segments, there is no second touch time segment between one group of two adjacent first touch time segments, and there is one second touch time segment between each of two groups of two adjacent first touch time segments. For example, there is no second touch time segment between two adjacent first touch time segments T7 and T8, and there is one second touch time segment T4 between two adjacent first touch time segments T3 and T5, and there is one second touch time segment T6 between two adjacent first touch time segments T5 and T7. The two adjacent first touch time segments T3 and T5 are one group of the two groups of two adjacent first touch time segments, the two adjacent first touch time segments T5 and T7 are the other group of the two groups of two adjacent first touch time segments, and the two groups of two adjacent first touch time segments share the first touch time segment T5.

FIG. 20 shows a schematic diagram of timing of display driving time segments and non-display driving time segments during a single image refresh cycle time segment in a case where an active object is sensed by a touch display device according to another embodiment of the present disclosure. In this example, one image refresh cycle includes six second touch time segments T1, T2, T5, T7, T9, T10 and four first touch time segments T3, T4, T6, T8, among the four first touch time segments, there is no second touch time segment between one group of two adjacent first touch time segments, and there is one second touch time segment between each of two groups of two adjacent first touch time segments. For example, there is no second touch time segment between two adjacent first touch time segments T3 and T4, and there is one second touch time segment T5 between two adjacent first touch time segments T4 and T6, and there is one second touch time segment T7 between two adjacent first touch time segments T6 and T8. The two adjacent first touch time segments T4 and T6 are one group of the two groups of two adjacent first touch time segments, the two adjacent first touch time segments T6 and T8 are the other group of the two groups of two adjacent first touch time segments, and the two groups of two adjacent first touch time segments share the first touch time segment T6.

FIG. 21 shows a schematic diagram of timing of display driving time segments and non-display driving time segments during a single image refresh cycle time segment in a case where an active object is sensed by a touch display device according to another embodiment of the present disclosure. In this example, one image refresh cycle includes six second touch time segments T1, T2, T4, T7, T9, T10 and four first touch time segments T3, T5, T6, T8, among the four first touch time segments, there is no second touch time segment between one group of two adjacent first touch time segments, and there is one second touch time segment between each of two groups of two adjacent first touch time segments. For example, there is no second touch time segment between two adjacent first touch time segments T5 and T6, and there is one second touch time segment T4 between two adjacent first touch time segments T3 and T5, and there is one second touch time segment T7 between two adjacent first touch time segments T6 and T8. The two adjacent first touch time segments T3 and T5 are one group of the two groups of two adjacent first touch time segments, the two adjacent first touch time segments T6 and T8 are the other group of the two groups of two adjacent first touch time segments, and there is no shared first touch time segment between the two groups of two adjacent first touch time segments.

In some embodiments, the interaction method between the external object and the touch display device further includes: the touch display device transmits an uplink signal to the external object, and periodically transmits the uplink signal to the external object with an image refresh cycle of the touch display device as a transmission cycle. For example, as shown in FIG. 5 and FIG. 7 to FIG. 21, the touch display device transmits an uplink signal to an external object during a time segment B, and a transmission cycle of the uplink signal is an image refresh cycle Tf. The uplink signal may define a cooperative operation between the touch display device and the active object (e.g., an active pen) or include a control signal required for a drive operation of the active object. For example, the uplink signal may include identification information, type information of the touch display device, characteristic information (e.g., frequency, number of pulses) of the downlink signal transmitted by the active object, and information for driving synchronization between the active object and the touch display device.

It should be noted that when the image refresh frequency of the touch display device is converted between different frequencies (for example, 60 Hz, 90 Hz, 120 Hz, and 144 Hz), the active object needs to perform real-time adjustment of the response to support variable frequency display technology of the touch display device.

In some embodiments, the uplink signal includes a first character field, and the first character field is used for characterizing a current image refresh cycle of the touch display device. In an implementation process, data strings “00”, “01”, “10”, and “11” may be adopted for the first character field, and correspondingly indicate that current image refresh cycles of the touch display device are 60 Hz, 90 Hz, 120 Hz, and 144 Hz. In response to the received uplink signal, the active object determines a current image refresh cycle of the touch display device according to the first character field, and transmits a downlink signal corresponding to the current image refresh cycle to the touch display device. For example, if it is determined that the current image refresh cycle of the touch display device is 60 Hz or 90 Hz, a downlink signal may be transmitted to the touch display device according to a transmission signal format in Table 1 or Table 2 below; if it is determined that the current image refresh cycle of the touch display device is 120 Hz, a downlink signal may be transmitted to the touch display device according to a transmission signal format in Table 3 or Table 4 below.

In some embodiments, the uplink signal further includes a second character field for characterizing a frequency at which the active object transmits a downlink signal to the touch display device. In an implementation process, the frequency at which the active object transmits the downlink signal to the touch display device is typically between 100 KHz and 400 KHz, such as 164.86 KHz, 195.12 KHz, 285.7 KHz, etc. The second character field may also use a data string to represent the frequency of the downlink signal. The active object determines, in response to the received uplink signal, a frequency at which the downlink signal needs to be transmitted to the touch display device according to the second character field, and transmits the downlink signal to the touch display device at the frequency.

In some embodiments, the uplink signal includes 7 bits of data. The uplink signal may be encoded using Direct Sequence Spread Spectrum (DSSS), and each bit of data is encoded as a P-bit spread spectrum code sequence, herein, P is a positive integer. Direct Sequence Spread Spectrum (DSSS) technology encodes each bit of data into a multi-bit spread spectrum code sequence (which may be referred to as a “chip”). On the surface, using Direct Sequence Spread Spectrum technology requires higher bandwidth, but the price is worth it. In the implementation process, the uplink signal may be encoded by Direct Sequence Spread Spectrum and Pseudo-Noise Code corresponding to a current image refresh cycle of the touch display device. FIG. 22 shows a circuit diagram of modulating and demodulating an uplink signal using Direct Sequence Spread Spectrum according to an embodiment of the present disclosure. As shown in FIG. 22, original data of the touch display device is defined to form an RS code, that is, a 7-bit source code of the uplink signal. After the uplink signal is modulated, the uplink signal is logically operated with a Pseudo-Noise Code (PN) to form a spread spectrum code sequence, and the spread spectrum code sequence is transmitted through contact between the active object and the touch display device. The active object uses the PN code to demodulate the spread spectrum code sequence, and after RS error correction, the original data is obtained. Among them, the PN code may correspond to the image refresh cycle of the touch display device in one-to-one correspondence, for example, when there are four kinds of image refresh cycles, which are represented by data strings “00”, “01”, “10”, and “11” respectively, there are also four kinds of PN codes, and each kind of PN code needs to be encoded with a corresponding data string to complete the modulation function. The PN code may be coded using 8-bit hexadecimal encoding and start with OX, with a minimum value of 0 and a maximum value of F. A specific value of each bit in the PN code may be customized according to product performance and a confidentiality requirement, and the embodiment of the present disclosure is not limited thereto. Taking a PN code corresponding to a data string “01” being 0X11011001 as an example, after an exclusive OR logic operation, data “0” is encoded with a chip “11011101” and data “1” is encoded with a chip “00100010”, so the data string “01” may be encoded as “1101110100100010”.

In some embodiments, each bit of data is encoded into a 31-bit spread spectrum code sequence. For example, the uplink signal transmits seven “0” or “1” characters, and each character is expanded into a 31-bit string of “0” or “1”, i.e., the uplink signal includes 7 bits of data, and each bit of data is encoded as a 31-bit spread spectrum code sequence, whereby the uplink signal includes a total of 217 bits of spread spectrum code sequence. The uplink signal may also be described as including 7-bit codes, each code includes a 31-bit pulse sequence, i.e. each code is represented by a 31-bit pulse sequence, a pulse potential of each bit in the 31-bit pulse sequence corresponds to “0” or “1”. Codes of different bits in the 7-bit codes may include different 31-bit pulse sequences. FIG. 23 shows an example of 7-bit codes in an uplink signal. Each of the 7-bit codes N0 to N6 includes a 31-bit pulse sequence, and correspondingly, the uplink signal includes a 217-bit pulse sequence. In some embodiments, a duration of each bit pulse is 1 microsecond, and a duration Td of pulse corresponding each bit code is 31 microseconds. A part of the 7-bit codes is used to implement signal synchronization between the touch display device and the active object, and a part of the codes may represent identification information of the touch display device, type information, a current image refresh cycle, characteristic information (e.g., frequency, quantity of pulses) of a downlink signal transmitted by the active object, and the like. Those skilled in the art may assign specific information contents to each code of the 7-bit codes according to practical applications, which is not particularly limited herein.

When the active object and the touch display device establish a connection, the active object may transmit a downlink signal to the touch display device. The downlink signal is sensed by the touch sensor, and the touch display device may determine a touch state of the active object based on the downlink signal. Information contents of the downlink signal may be set according to actual application needs, and in some embodiments, the downlink signal may include a number of the active object, a key press state of the active object, touch pressure information of the active object, tilt angle information of the active object, power supply information of the active object, information for error detection and correction, and the like.

In some embodiments, the touch signal (e.g., a downlink signal) of the active object includes pressure information indicating a touch pressure of the active object for the touch display device, and the pressure information includes multi-bit pressure information codes. Sensing the touch signal of the active object via the touch sensor during the plurality of second touch time segments to detect touch of the active object to the touch display device includes: receiving pressure information codes of different bits of the multi-bit pressure information codes via the touch sensor during at least two second touch time segments of the plurality of second touch time segments, respectively.

For the previously described embodiment in which the image refresh cycle includes eight second touch time segments and four first touch time segments, there are two second touch time segments between each two adjacent first touch time segments. In this case, the pressure information may include twelve-bit pressure information codes, and receiving pressure information codes of different bits of the multi-bit pressure information codes via the touch sensor during at least two of the plurality of second touch time segments, respectively includes: receiving the twelve-bit pressure information codes via the touch sensor during six second touch time segments of the eight second touch time segments, respectively, and receiving two-bit pressure information codes of the twelve-bit pressure information codes via the touch sensor during each second touch time segment of the six second touch time segments.

Table 1 and Table 2 show two exemplary formats of the downlink signal received by the touch display device. An example of receiving different pressure information code bits in the multi-bit pressure information codes via the touch sensor is described below with reference to Tables 1, 2, and FIG. 5.

As shown in FIG. 5, the image refresh cycle includes eight second touch time segments T1, T2, T4, T5, T8, T9, T11, and T12. As shown in Tables 1 and 2, twelve-bit pressure information codes “pressure 0”, “pressure 1”, . . . “pressure 11” are received via the touch sensor during the second touch time segments T1, T2, T4, T8, T9, and T11, and two-bit pressure information codes among the twelve-bit pressure information codes are received respectively via the touch sensor during each of the six second touch time segments T1, T2, T4, T8, T9, and T11. For example, during the second touch time segment T11, the touch display device receives “pressure 0” and “pressure 1” from an active object (e.g., active pen) via a touch sensor, during the second touch time segment T9, the touch display device receives “pressure 2” and “pressure 3” from the active object (e.g., active pen) via the touch sensor, the touch display device receives “pressure 10” and “pressure 11” from the active object (e.g., active pen) via a touch sensor. As a result, the touch pressure information represented by the twelve-bit pressure information codes is received by the touch display device in a time-scattered manner, which is beneficial for the touch display device to be compatible with an active object (for example, an active pen) having a higher point reporting rate, in other words, if the active pen currently matched with the touch display device is upgraded to an active pen having a higher point reporting rate, the accuracy and reliability of the active pen in terms of point reporting rate can also be better ensured.

TABLE 1

| Time | | |
|---|---|---|
| segment | Code bit | Data |
| T1 | Bit2 | Pen number |
| | Bit1 | Pressure 11 |
| | Bit0 | Pressure 10 |
| T2 | Bit2 | H/I |
| | Bit1 | Pressure 9 |
| | Bit0 | Pressure 8 |
| T4 | Bit2 | Key 1 |
| | Bit1 | Pressure 7 |
| | Bit0 | Pressure 6 |
| T5 | Bit2 | Key 0 |
| | Bit1 | CRC3 |
| | Bit0 | CRC2. |
| T8 | Bit2 | Power 3 |
| | Bit1 | Pressure 5 |
| | Bit0 | Pressure 4 |
| T9 | Bit2 | Power 2 |
| | Bit1 | Pressure 3 |
| | Bit0 | Pressure 2 |
| T11 | Bit2 | Power 1 |
| | Bit1 | Pressure 1 |
| | Bit0 | Pressure 0 |
| T12 | Bit2 | Power 0 |
| | Bit1 | CRC1 |
| | Bit0 | CRC0 |

TABLE 2

| Time | | |
|---|---|---|
| segment | Code bit | Data |
| T1 | Bit2 | Pen number |
| | Bit1 | Pressure 11 |
| | Bit0 | Pressure 10 |
| T2 | Bit2 | H/I |
| | Bit1 | Pressure 9 |
| | Bit0 | Pressure 8 |
| T4 | Bit2 | Tilt 5 |
| | Bit1 | Pressure 7 |
| | Bit0 | Pressure 6 |
| T5 | Bit2 | Tilt 4 |
| | Bit1 | CRC3 |
| | Bit0 | CRC2 |
| T8 | Bit2 | Tilt 3 |
| | Bit1 | Pressure 5 |
| | Bit0 | Pressure 4 |
| T9 | Bit2 | Tilt 2 |
| | Bit1 | Pressure 3 |
| | Bit0 | Pressure 2 |
| T11 | Bit2 | Tilt 1 |
| | Bit1 | Pressure 1 |
| | Bit0 | Pressure 0 |
| T12 | Bit2 | Tilt 0 |
| | Bit1 | CRC1 |
| | Bit0 | CRC0 |

For the previously described embodiment in which the image refresh cycle includes six second touch time segments and four first touch time segments, there are two second touch time segments between each two adjacent first touch time segments of four first touch time segments. In this case, the pressure information may also include twelve-bit pressure information code, and receiving pressure information codes of different bits of the multi-bit pressure information codes via the touch sensor during at least two of the plurality of second touch time segments, respectively, includes receiving the twelve-bit pressure information codes via the touch sensor during two of the six second touch time segments, respectively, and receiving six-bit pressure information codes of the twelve-bit pressure information codes via the touch sensor during each of the two second touch time segments.

Table 3 shows an exemplary format of a downlink signal received by the touch display device when encoded with Differential Quadrature Reference Phase Shift Keying (DQPSK), and Table 4 shows an exemplary format of a downlink signal received by the touch display device when encoded with Quadrature Phase Shift Keying (QPSK). An example of receiving different pressure information code bits in the multi-bit pressure information codes via the touch sensor is described below with reference to Tables 3, 4, and FIG. 12.

As shown in FIG. 12, the image refresh cycle includes six second touch time segments T2, T3, T5, T6, T8, and T9. As shown in Table 3, twelve-bit pressure information codes “pressure 0”, “pressure 1”, . . . “pressure 11” are received via the touch sensor during the second touch time segment T5 and T6, and six-bit pressure information codes of the twelve-bit pressure information codes are received via the touch sensor during each of the two second touch time segments T5 and T6, respectively. For example, during the second touch time segment T5, the touch display device receives “pressures 6-11” from the active object (e.g., active pen) via the touch sensor, and during the second touch time segment T6, the touch display device receives “pressures 0-5” from the active object (e.g., active pen) via the touch sensor. As shown in Table 4, twelve-bit pressure information codes “pressure 0”, “pressure 1”, . . . “pressure 11” are received via the touch sensor during the second touch time segment T8 and T9, and six-bit pressure information codes of the twelve-bit pressure information codes are received via the touch sensor during each of the two second touch time segments T8 and T9, respectively. For example, during the second touch time segment T8, the touch display device receives “pressures 6-11” from the active object (e.g., active pen) via the touch sensor, and during the second touch time segment T9, the touch display device receives “pressures 0-5” from the active object (e.g., active pen) via the touch sensor.

TABLE 3

| Time | | |
|---|---|---|
| segment | Code bit | Data |
| T2 | Bit4~9 | Data (Reserved) |
| | Bit2~3 | Pen number |
| | Bit0~1 | Tilt 8~9 |
| T3 | Bit8~9 | Tilt 6~7 |
| | Bit4~7 | Power 4~7 |
| | Bit0~3 | Power 0~3 |
| T5 | Bit8~9 | Tilt 4~5 |
| | Bit4~7 | Pressure 6~11 |
| | Bit0~3 | H/I0~1 |
| T6 | Bit8~9 | Tilt 2~3 |
| | Bit4~7 | Pressure 0~5 |
| | Bit0~3 | Key 0 ~1 |
| T8 | Bit8~9 | Tilt 0~1 |
| | Bit4~7 | Data4~7 |
| | Bit0~3 | Data0~3 |
| T9 | Bit4~9 | Data (Reserved) |
| | Bit2~3 | CRC2~3 |
| | Bit0~1 | CRC0~1 |

TABLE 4

| Time | | |
|---|---|---|
| segment | Code bit | Data |
| T2 | Bit8~9 | Pen number (Reserved) |
| | Bit2~7 | Pressure (Reserved) |
| | Bit0~1 | H/I0~1 |
| T3 | Bit8~9 | Data8~9 |
| | Bit2~7 | Pressure (Reserved) |
| | Bit0~1 | Tilt 6~7 |
| T5 | Bit6~9 | Power 4~7 |
| | Bit2~5 | Power 0~3 |
| | Bit0~1 | Tilt 4~5 |
| T6 | Bit7~9 | Data5~7 |
| | Bit2~6 | Data0~4 |
| | Bit0~1 | Tilt 2~3 |
| T8 | Bit8~9 | Key 0~1 |
| | Bit2~7 | Pressure 6~11 |
| | Bit0~1 | Tilt 0~1 |
| T9 | Bit4~9 | Pressure 0~5 |
| | Bit2~3 | CRC2~3 |
| | Bit0~1 | CRC0~1 |

In some embodiments, the active object includes a power supply, and a touch signal of the active object includes power supply information for indicating a state of the power supply, for example, a downlink signal transmitted by the active object to the touch display device includes power supply information. The power supply information includes multi-bit power supply information codes, in which case sensing the touch signal of the active object via the touch sensor during the plurality of second touch time segments to detect touch of the active object to the touch display device includes: receiving power supply information codes of different bits of the multi-bit power supply information codes via the touch sensor during at least two of the plurality of second touch time segments or during one of the plurality of second touch time segments, respectively.

Referring to Table 1 and FIG. 5 together, the power supply information includes four-bit power supply information codes “power 0”, “power 1”, “power 2”, and “power 3”. A respective one-bit power information code is received via the touch sensor during the second touch time segments T12, T11, T9, and T8, respectively. That is, the four-bit power supply information codes are received via the touch sensor during four second touch time segments of the eight second touch time segments, respectively. In the example shown in Table 1, the touch pressure information of the active object includes twelve-bit pressure information codes, and thus, the touch pressure determined by the touch display device may include a 4096 gradient. The power information includes four-bit power supply information codes, and the power state of the active object may be expressed as a 16-gradient.

Referring to Table 3 and FIG. 12 together, the power supply information includes eight-bit power supply information codes “power level 0” to “power level 7” that are received via the touch sensor during the second touch time segment T3. Referring to Table 4 and FIG. 12 together, the power supply information includes eight-bit power supply information codes “power level 0” to “power level 7” that are received via the touch sensor during the second touch time segment T5. That is, the eight-bit power supply information codes are received via the touch sensor during one of the six second touch time segments.

In some embodiments, the active object includes a plurality of keys, the touch signal of the active object includes key information for indicating states of the plurality of keys, and the key information includes multi-bit key information codes corresponding to the plurality of keys. In this case sensing the touch signal of the active object via the touch sensor during the plurality of second touch time segments to detect touch of the active object to the touch display device includes: receiving key information codes of different bits of the multi-bit key information codes via the touch sensor during at least two of the plurality of second touch time segments or during one of the plurality of second touch time segments, respectively. Referring to Table 1 and FIG. 5 together, key information codes “Key 0” and “Key 1” are received during second touch time segments T5 and T4, respectively. The key information codes “key 0” and “key 1” may correspond to different keys of the active object, respectively. Referring to Table 3 and FIG. 12 together, key information codes “keys 0 to 1” (i.e., “key 0” and “key 1”) are received during the second touch time segment T6. Referring to Table 4 and FIG. 12 together, key information codes “keys 0 to 1” are received during the second touch time segment T8.

In some embodiments, the touch signal of the active object includes tilt angle information indicating a tilt angle of the active object relative to the touch display device, and the tilt angle information includes multi-bit tilt angle information codes. Sensing the touch signal of the active object via the touch sensor during the plurality of second touch time segments to detect touch of the active object to the touch display device includes: receiving tilt angle information codes of different bits of the multi-bit tilt angle information codes via the touch sensor during at least two second touch time segments of the plurality of second touch time segments, respectively.

Referring to Table 2 and FIG. 5 together, the tilt angle information may include six-bit tilt angle information codes “Tilt 0” to “Tilt 5”, and a total of six-bit tilt angle information codes of “Tilt 5”, “Tilt 4”, “Tilt 3”, “Tilt 2”, “Tilt 1”, and “Tilt 0” are correspondingly received via the touch sensor during the second touch time segments T4, T5, T8, T9, T11, and T12. That is, the six-bit tilt angle information codes are received via the touch sensor during six second touch time segments of the eight second touch time segments, respectively.

Referring to Table 3 and FIG. 12 together, the tilt angle information may include ten-bit tilt angle information codes “Tilt 0” to “Tilt 9”, “Tilt 8” and “Tilt 9” are correspondingly received via the touch sensor during the second touch time segment T2, “Tilt 6” and “Tilt 7” are correspondingly received via the touch sensor during the second touch time segment T3, “Tilt 4” and “Tilt 5” are correspondingly received via the touch sensor during the second touch time segment T5, “Tilt 2” and “Tilt 3” are correspondingly received via the touch sensor during the second touch time segment T6, and “Tilt 0” and “Tilt 1” are correspondingly received via the touch sensor during the second touch time segment T8. That is, during five of the six second touch time segments, the ten-bit tilt angle information codes are received via the touch sensor, and during each of the five second touch time segments, two-bit tilt angle information codes of the ten-bit tilt angle information codes are respectively received via the touch sensor.

Referring to Table 4 and FIG. 12 together, the tilt angle information may include eight-bit tilt angle information codes “Tilt 0” to “Tilt 7”, “Tilt 6” and “Tilt 7” are correspondingly received via the touch sensor during the second touch time segment T3, “Tilt 4” and “Tilt 5” are correspondingly received via the touch sensor during the second touch time segment T5, “Tilt 2” and “Tilt 3” are correspondingly received via the touch sensor during the second touch time segment T6, and “Tilt 0” and “Tilt 1” are correspondingly received via the touch sensor during the second touch time segment T8. That is, during four of the six second touch time segments, the eight-bit tilt angle information codes are received via the touch sensor, and during each of the four second touch time segments, two-bit tilt angle information codes of the eight-bit tilt angle information codes are respectively received via the touch sensor.

In some embodiments, the touch signal of the active object includes hover information for indicating that the active object is in a hover state, and identification information for indicating an identification of the active object, the hover information includes a hover information code, and the identification information includes an identification information code. In this case, sensing the touch signal of the active object via the touch sensor during the plurality of second touch time segments to detect touch of the active object to the touch display device includes: receiving the hover information code and the identification information code via the touch sensor during different second touch time segments or a same second touch time segment of the plurality of second touch time segments, respectively. In the examples shown in Tables 1 and 2, during the second touch time segment T1, the touch display device receives an identification information code “pen number” of the active object; during the second touch time segment T2, the touch display device receives a hover information code “H/I”. In the example shown in Table 3, during the second touch time segment T2, the touch display device receives the identification information code “pen number” of the active object; during the second touch time segment T5, the touch display device receives the hover information code “H/I”. In the example shown in Table 4, during the second touch time segment T2, the touch display device receives the identification information code “pen number” of the active object and the hover information code “H/I”.

In some embodiments, the touch signal of the active object may include multi-bit touch signal codes, and the multi-bit touch signal codes include one or more of the following: the multi-bit pressure information codes, the multi-bit power supply information codes, the multi-bit key information codes, the multi-bit tile angle information codes, the hover information code, and the identification information code. The multi-bit touch signal codes of the touch signal of the active object may also include a check bit code, for example, four-bit check codes CRC 0, CRC 1, CRC 2, and CRC 3 as shown in Tables 1 to 4, and integrity of the touch signal code may be detected by setting a check bit code. However, embodiments of the present disclosure are not limited thereto, and the touch signal of the active object may also include any other appropriate information codes.

In some embodiments, sensing the touch signal of the active object via the touch sensor during the plurality of second touch time segments to detect touch of the active object to the touch display device includes: receiving three-to-ten-bit touch signal codes of the multi-bit touch signal codes via the touch sensor during each of the second touch time segments.

For the examples shown in Tables 1 and 2, three-bit touch signal codes of the multi-bit touch signal codes are received via the touch sensor during each of the second touch time segments. During each of the second touch time segments T1, T2, T4, T5, T8, T9, T11, and T12, the three-bit touch signal codes are denoted as Bit 0, Bit 1, and Bit 2. For the examples shown in Tables 3 and 4, ten-bit touch signal codes of the multi-bit touch signal codes are received via the touch sensor during each of the second touch time segments. During each of the second touch time segments T2, T3, T5, T6, T8, and T9, the ten-bit touch signal codes are denoted as Bit 0, Bit 1, . . . Bit 9. In some other embodiments, six-bit touch signal codes of the multi-bit touch signal codes may also be received via the touch sensor during each of the second touch time segments.

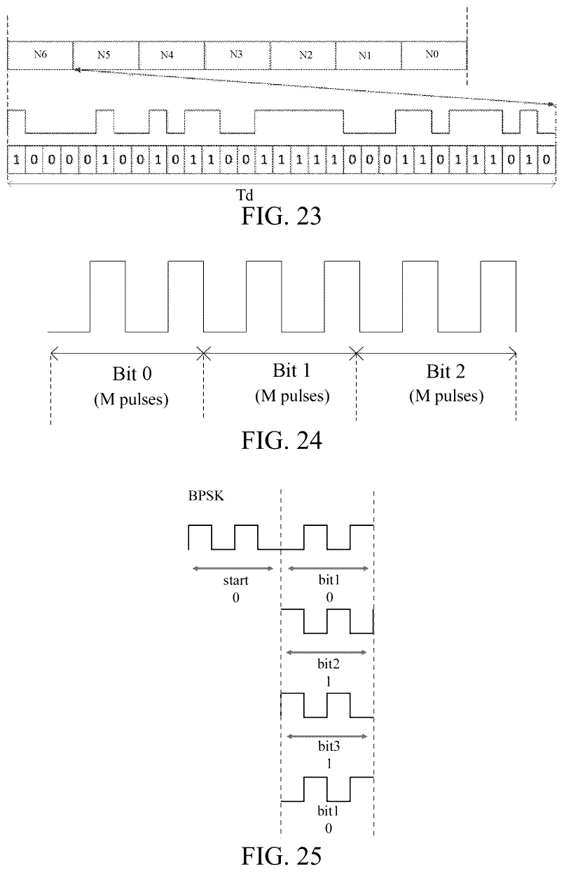

In some embodiments, each touch signal code of the multi-bit touch signal codes includes a multi-bit pulse sequence, and phases of multi-bit pulse sequences of touch signal codes of different bits of the multi-bit touch signal codes are different. As shown in FIG. 24, codes Bit 0, Bit 1, and Bit 2 of the three-bit touch signal codes each includes a multi-bit pulse sequence (e.g., each includes M pulses), but there may be differences in phases of pulse sequences of different bit codes. For example, phases of pulse sequences of the touch signal codes Bit 0 and Bit 1 may differ by 180 or 90 degrees, thereby expressing information content of touch signal codes of different bits.

It is to be understood that the touch signal of the active object may be encoded based on Binary Phase Shift Keying (BPSK) or Quadrature Phase Shift Keying (QPSK) or the like. In some embodiments, at least one of BPSK, a variant of the BPSK encoding method such as Differential Binary Phase Shift Keying (DBPSK), QPSK, a variant of the QPSK encoding method such as Differential Quadrature Reference Phase Shift Keying (DQPSK) may be used for encoding, and these encoding methods may use a relative phase change of a carrier wave to transmit digital information, for example, by using a relative phase change of carrier waves of adjacent symbols front and rear to transmit digital information.

In some embodiments, if the image refresh frequency of the touch display device is 60 Hz or 90 Hz, the touch signal may be encoded and decoded using BPSK. FIG. 25 shows a schematic diagram of a theoretical model of BPSK data according to an embodiment of the present disclosure, as shown in FIG. 25, each bit of data includes a 2-bit pulse sequence, a phase difference between a pulse sequence in Bit1 and a pulse sequence in start is 180°, a phase difference between a pulse sequence in Bit2 and the pulse sequence in start is 0°, and a phase difference between a pulse sequence in Bit3 and the pulse sequence in start is 0°. When encoding is performed by BPSK, an encoding format of a phase variation of the touch signal of the active object may be set with reference to the theoretical model of BPSK data as shown in FIG. 25. In an implementation process, the encoding format may be set to 3-10 bits of data, each bit of data includes 3-13 bits of pulse sequence and is coded and arranged according to a phase difference of 180°, and then the touch signal is BPSK encoded according to the set encoding format to obtain the touch signal code. Taking the encoding format including 4 bits of data, each bit of data including 4 bits of pulse sequence and arranged according to the phase difference of 180° as an example, the touch signal is BPSK encoded according to the encoding format to obtain a four-bit touch signal codes.

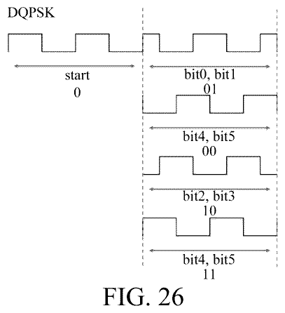

In some embodiments, if the image refresh frequency of the touch display device is 120 Hz, the touch signal may be encoded and decoded using QPSK or DQPSK. FIG. 26 shows a schematic diagram of a theoretical model of DQPSK data according to an embodiment of the present disclosure, as shown in FIG. 26, each bit of data includes a 2-bit pulse sequence, a phase difference between a pulse sequence in Bit0 and Bit1 and a pulse sequence in start is 90°, a phase difference between a pulse sequence in Bit2 and Bit3 and the pulse sequence in start is 270°, and a phase difference between a pulse sequence in Bit4 and Bit5 and the pulse sequence in start is 180° or 0°. When encoding is performed by DQPSK, an encoding format of a phase variation of the touch signal of the active object may be set with reference to the theoretical model of DQPSK data as shown in FIG. 26. In an implementation process, the encoding format may be set to 3-10 bits of data, each bit of data includes 3-13 bits of pulse sequence and is coded and arranged according to a phase difference of 90°, and then the touch signal is DQPSK encoded according to the set encoding format to obtain the touch signal code. Taking the encoding format including 4 bits of data, each bit of data including 4 bits of pulse sequence and arranged according to the phase difference of 90° as an example, the touch signal is DQPSK encoded according to the encoding format to obtain a six-bit touch signal codes. It should be noted that when the touch signal is encoded by the DQPSK method, an amount of data transmitted by the active object in a same time is three times that of the BPSK method, and a data transmission rate is higher.

Another embodiment of the present disclosure provides a touch processor including: a memory configured to store computer-executable instructions; a data processor configured to, when the computer-executable instructions are executed by the data processor, perform the method as described in the foregoing embodiment of an interaction method between an external object and a touch display device.

The steps in the method described in the embodiment of the interaction method between the external object and the touch display device described above may be implemented as a computer program. For example, an embodiment of the present application provides a computer program product including a computer program carried on a computer readable medium, and the computer program includes program codes for performing at least one step in an interaction method between an external object and a touch display device described in the above embodiments.

Another embodiment of the present application provides one or more computer-readable storage media having stored thereon computer-readable instructions that, when executed, implement an interaction method between an external object and a touch display device according to some embodiments of the present application. Various steps of the interaction method between the external object and the touch display device may be translated into computer-readable instructions by programming, thereby stored in a computer-readable storage medium. When such a computer-readable storage medium is read or accessed by a computing device or computer, the computer-readable instructions therein are executed by a processor on the computing device or computer to implement an interaction method between an external object and a touch display device.

Another embodiment of the present disclosure provides a touch display device including a touch sensor and a touch processor configured to perform a method as described in the foregoing embodiment of an interaction method between an external object and a touch display device.

Another embodiment of the present disclosure provides a touch system including a touch display device and an active object as described in a preceding embodiment, the active object is configured to transmit a downlink signal to the touch display device in response to receiving an uplink signal, and the active object includes an active pen.

In some embodiments, the active object is also configured to determine a current image refresh cycle of the touch display device according to the uplink signal, and to transmit a downlink signal corresponding to the current image refresh cycle to the touch display device.

Another embodiment of the present disclosure provides a computer program product including a computer program that, when executed by a processor, implements an interaction method as described in any one of the foregoing method embodiments.

Although the present application has been described in connection with some embodiments, it is not intended to be limited to specific forms set forth herein. Rather, a scope of the present application is limited only by appended claims. Additionally, although separate features may be included in different claims, these may possibly be advantageously combined, and inclusion in different claims does not imply that a combination of features is not feasible and/or advantageous. A sequence of features in the claims does not imply that the features must work in any particular sequence.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. An interaction method between an external object and a touch display device, wherein the touch display device comprises a touch sensor, and the interaction method comprises:
one image refresh cycle of the touch display device comprises a plurality of display driving time segments and a plurality of non-display driving time segments, a display driving time segment and a non-display driving time segment alternate with each other, the plurality of non-display driving time segments comprise a plurality of first touch time segments and a plurality of second touch time segments, each of the first touch time segments or each of the second touch time segments is one of the non-display driving time segments, respectively, wherein the one image refresh cycle comprises at least two of the second touch time segments located between at least two of first touch time segments; and
the external object comprises at least one of an active object and a passive object, receiving, by the touch display device, a communication signal from the active object, sensing a touch signal of the passive object via the touch sensor during the plurality of first touch time segments to detect touch of the passive object to the touch display device, and sensing a touch signal of the active object via the touch sensor during the plurality of second touch time segments to detect touch of the active object to the touch display device.

16. The interaction method according to claim 15, wherein the one image refresh cycle comprises at least two of the second touch time segments located between one group of two adjacent first touch time segments, or the one image refresh cycle comprises at least two of the second touch time segments located between two groups of two adjacent first touch time segments, respectively.

17. The interaction method according to claim 16, wherein there is at least one second touch time segment between each two adjacent first touch time segments in the one image refresh cycle.

18. (canceled)

19. (canceled)

20. (canceled)

21. The interaction method according to claim 16, wherein there is no second touch time segment between at least one group of two adjacent first touch time segments in the one image refresh cycle.

22. (canceled)

23. (canceled)

24. The interaction method according to claim 16, further comprising: transmitting, by the touch display device, an uplink signal to the external object, and periodically transmitting the uplink signal to the external object with an image refresh cycle of the touch display device as a transmission cycle, and a time segment corresponding to the uplink signal comprises a noise processing time segment.

25. The interaction method according to claim 24, wherein detecting touch of the passive object to the touch display device and detecting touch of the active object to the touch display device comprise collecting the touch signal of the passive object sensed by the touch sensor and collecting the touch signal of the active object sensed by the touch sensor, respectively, and the interaction method further comprising:
acquiring a signal-to-noise ratio of at least one of the touch signal of the active object and the touch signal of the passive object during the noise processing time segment; and
in response to the signal-to-noise ratio being lower than a threshold, adjusting a frequency at which the at least one of the touch signal of the active object and the touch signal of the passive object is collected.

26. The interaction method according to claim 16, wherein a time length of each first touch time segment of the plurality of first touch time segments and a time length of each second touch time segment of the plurality of second touch time segments each does not exceed a first threshold.

27. The interaction method according to claim 26, wherein the first threshold is 180 microseconds.

28. The interaction method according to claim 26, wherein each of the first touch time segments and each of the second touch time segments have a same time length.

29. The interaction method according to claim 16, further comprising:
if the touch display device does not receive the communication signal from the active object, not detecting, by the touch display device, touch of the active object and the passive object to the touch display device during two non-display driving time segments of the plurality of non-display driving time segments, and detecting, by the touch display device, the touch signal of the passive object sensed via the touch sensor during other non-display driving time segments other than the two non-display driving time segments of the plurality of non-display driving time segments to detect touch of the passive object to the touch display device.

30. (canceled)

31. The interaction method according to claim 16, further comprising:
transmitting, by the touch display device, an uplink signal to the external object, and periodically transmitting the uplink signal to the external object with an image refresh cycle of the touch display device as a transmission cycle, wherein the uplink signal comprises a first character field, and the first character field is used for characterizing a current image refresh cycle of the touch display device.

32. The interaction method according to claim 31, wherein the uplink signal further comprises a second character field, and the second character field is used for characterizing a frequency at which the active object transmits a downlink signal to the touch display device.

33. (canceled)

34. (canceled)

35. (canceled)

36. The interaction method according to claim 31, wherein the uplink signal is encoded using direct sequence spread spectrum, and a pseudo-noise code corresponding to the current image refresh cycle of the touch display device.

37. The interaction method according to claim 16, wherein the touch signal of the active object comprises pressure information indicating a touch pressure of the active object for the touch display device, and the pressure information comprises multi-bit pressure information codes, wherein sensing the touch signal of the active object via the touch sensor during the plurality of second touch time segments to detect touch of the active object to the touch display device comprises:
receiving pressure information codes of different bits of the multi-bit pressure information codes via the touch sensor during at least two second touch time segments of the plurality of second touch time segments, respectively; and
wherein the one image refresh cycle comprises six second touch time segments and four first touch time segments, there are two second touch time segments between each two adjacent first touch time segments of the four first touch time segments, and the pressure information comprises twelve-bit pressure information codes, wherein receiving pressure information codes of different bits of the multi-bit pressure information codes via the touch sensor during the at least two of the plurality of second touch time segments, respectively, comprises:
receiving the twelve-bit pressure information codes via the touch sensor during two second touch time segments of the six second touch time segments, respectively, and receiving two-bit pressure information codes of the twelve-bit pressure information codes via the touch sensor during each second touch time segment of the two second touch time segments, respectively.

38. (canceled)

39. The interaction method according to claim 16, wherein the active object comprises a power supply, the touch signal of the active object comprises power supply information indicating a state of the power supply, and the power supply information comprises multi-bit power supply information codes, wherein sensing the touch signal of the active object via the touch sensor during the plurality of second touch time segments to detect touch of the active object to the touch display device, comprises:
receiving power supply information codes of different bits of the multi-bit power supply information codes via the touch sensor during one second touch time segment of the plurality of second touch time segments; and
wherein the one image refresh cycle comprises six second touch time segments and four first touch time segments, there are two second touch time segments between each two adjacent first touch time segments of the four first touch time segments, and the power supply information comprises eight-bit power supply information codes, wherein receiving the power supply information codes of different bits of the multi-bit power supply information codes via the touch sensor during the one second touch time segment of the plurality of second touch time segments, comprises:
receiving the eight-bit power supply information codes via the touch sensor during one second touch time segment of the six second touch time segments.

40. (canceled)

41. The interaction method according to claim 16, wherein the active object comprises a plurality of keys, the touch signal of the active object comprises key information indicating states of the plurality of keys, and the key information comprises multi-bit key information codes corresponding to the plurality of keys, wherein sensing the touch signal of the active object via the touch sensor during the plurality of second touch time segments to detect touch of the active object to the touch display device, comprises:
receiving key information codes of different bits of the multi-bit key information codes via the touch sensor during one second touch time segment of the plurality of second touch time segments.

42. The interaction method according to claim 16, wherein the touch signal of the active object comprises tilt angle information indicating a tilt angle of the active object relative to the touch display device, and the tilt angle information comprises multi-bit tilt angle information codes, wherein sensing the touch signal of the active object via the touch sensor during the plurality of second touch time segments to detect touch of the active object to the touch display device, comprises:
receiving tilt angle information codes of different bits of the multi-bit tilt angle information codes via the touch sensor during at least two second touch time segments of the plurality of second touch time segments, respectively.

43. The interaction method according to claim 42, wherein the one image refresh cycle comprises six second touch time segments and four first touch time segments, there are two second touch time segments between each two adjacent first touch time segments of the four first touch time segments, the tilt angle information comprises ten-bit tilt angle information codes, and receiving tilt angle information codes of different bits of the multi-bit tilt angle information codes via the touch sensor during at least two of the plurality of second touch time segments, respectively, comprises:
receiving the ten-bit tilt angle information codes via the touch sensor during five of the six second touch time segments, and receiving two-bit tilt angle information codes of the ten-bit tilt angle information codes via the touch sensor during each of the five second touch time segments, respectively.

44. The interaction method according to claim 42, wherein the one image refresh cycle comprises six second touch time segments and four first touch time segments, there are two second touch time segments between each two adjacent first touch time segments of the four first touch time segments, and the tilt angle information comprises eight-bit tilt angle information codes, wherein receiving the tilt angle information codes of different bits of the multi-bit tilt angle information codes via the touch sensor during the at least two second touch time segments of the plurality of second touch time segments, respectively, comprises:
receiving the eight-bit tilt angle information codes via the touch sensor during four second touch time segments of the six second touch time segments, and receiving two-bit tilt angle information codes of the eight-bit tilt angle information codes via the touch sensor during each second touch time segment of the four second touch time segments, respectively.

45. The interaction method according to claim 16, wherein the touch signal of the active object comprises hover information indicating that the active object is in a hover state and identification information indicating an identification of the active object, the hover information comprises a hover information code, and the identification information comprises an identification information code, wherein sensing the touch signal of the active object via the touch sensor during the plurality of second touch time segments to detect touch of the active object to a touch display device, comprises:
receiving the hover information code and the identification information code via the touch sensor during different second touch time segments or a same second touch time segment of the plurality of second touch time segments, respectively.

46. The interaction method according to claim 16, wherein the touch signal of the active object comprises multi-bit touch signal codes, the multi-bit touch signal codes comprise at least one of: multi-bit pressure information codes, multi-bit power supply information codes, multi-bit key information codes, multi-bit tilt angle information codes, a hover information code, an identification information code, and a check bit code, wherein sensing the touch signal of the active object via the touch sensor during the plurality of second touch time segments to detect touch of the active object to the touch display device, comprises:
receiving three-to-ten-bit touch signal codes of the multi-bit touch signal codes via the touch sensor during each of the second touch time segments.

47. The interaction method according to claim 46, wherein each touch signal code of the multi-bit touch signal codes comprises a multi-bit pulse sequence, and phases of multi-bit pulse sequences of touch signal codes of different bits of the multi-bit touch signal codes are different.

48. The interaction method according to claim 46, wherein the touch signal of the active object is encoded based on a Quadrature Phase Shift Keying (QPSK) format.

49. (canceled)

50. A computer-readable storage medium, storing computer-executable instructions, when the computer-executable instructions are executed, an interaction method according to claim 1.

51. A touch display device, comprising a touch sensor and a touch processor,
wherein the touch processor is configured to perform an interaction method according to claim 1.

52. A touch system, comprising a touch display device according to claim 51 and an active object,
wherein the active object is configured to transmit a downlink signal to the touch display device in response to receiving the uplink signal, and the active object comprises an active pen.

53. The touch system according to claim 52, wherein the active object is further configured to determine a current image refresh cycle of the touch display device according to the uplink signal, and to transmit a downlink signal corresponding to the current image refresh cycle to the touch display device.

54. (canceled)
